(19) United States
(12) Patent Application Publication
(10) Pub. No.: US 2025/0286674 A1
(43) Pub. Date: Sep. 11, 2025

(54) DYNAMIC TIMING ADVANCE (TA) INDICATION IN DOWNLINK CONTROL INFORMATION (DCI)

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US)

(21) Appl. No.: 18/857,419

(22) PCT Filed: Jun. 29, 2022
(86) PCT No.: PCT/CN2022/102305

§ 371 Date: Oct. 16, 2024

(51) Int. Cl. H04L 5/00; H04W 72/11; H04W 72/1263; H04W 72/232

(52) U.S. Cl. CPC H04L 5/0044; H04W 72/11; H04W 72/1263; H04W 72/232

(57) ABSTRACT

This disclosure provides systems, methods and apparatus, including computer programs encoded on computer storage media, for dynamic timing advance (TA) indication in downlink control information (DCI). Described techniques relate to indicating a TA command in a DCI message. For a DCI message configured to schedule an uplink or downlink communication, one or more fields of the DCI message may be repurposed and populated with values that indicate that the DCI message includes a TA command and the TA command itself. A user equipment (UE) may communicate an uplink message to the network in accordance with the indicated TA command. The TA command may indicate a timing adjustment value relative to a previous TA or an absolute TA value. The DCI message may indicate whether the TA command is a relative or absolute TA adjustment.

### CROSS REFERENCE

The present Application is a 371 national stage filing of International PCT Application No. PCT/CN2022/102305 by GUO et al. entitled “DYNAMIC TIMING ADVANCE (TA) INDICATION IN DOWNLINK CONTROL INFORMATION (DCI),” filed Jun. 29, 2022, which is assigned to the assignee hereof, and which is expressly incorporated by reference in its entirety herein.

### TECHNICAL FIELD

This disclosure relates to wireless communications, including dynamic timing advance indication in downlink control information.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (BSs) or one or more network access nodes, each simultaneously supporting communication for multiple communication devices, which may be otherwise known as user equipment (UE).

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication at a user equipment (UE). The method includes receiving a downlink control information (DCI) message including one or more fields associated with scheduling information for a communication between the UE and a network entity, where the DCI message is received in a DCI format that includes a cyclic redundancy check (CRC) scrambled by a configured scheduling radio network temporary identifier (CS-RNTI), the one or more fields being populated with values that indicate that the DCI message includes a timing advance command, and transmitting, to the network entity, an uplink message associated with the timing advance command indicated in the DCI message.

Another innovative aspect of the subject matter described in this disclosure can be implemented in an apparatus for wireless communication at a UE. The apparatus includes one or more interfaces configured to obtain a DCI message including one or more fields associated with scheduling information for a communication between the UE and a network entity, where the DCI message is received in a DCI format that includes an CRC scrambled by a CS-RNTI, the one or more fields being populated with values that indicate that the DCI message includes a timing advance command, and output, to the network entity, an uplink message associated with the timing advance command indicated in the DCI message.

Another innovative aspect of the subject matter described in this disclosure can be implemented in an apparatus for wireless communication at a UE. The apparatus includes means for receiving a DCI message including one or more fields associated with scheduling information for a communication between the UE and a network entity, where the DCI message is received in a DCI format that includes an CRC scrambled by a CS-RNTI, the one or more fields being populated with values that indicate that the DCI message includes a timing advance command, and means for transmitting, to the network entity, an uplink message associated with the timing advance command indicated in the DCI message.

Another innovative aspect of the subject matter described in this disclosure can be implemented in a non-transitory computer-readable medium storing code for wireless communication at a UE. The code includes instructions executable by a processor to receive a DCI message including one or more fields associated with scheduling information for a communication between the UE and a network entity, where the DCI message is received in a DCI format that includes an CRC scrambled by a CS-RNTI, the one or more fields being populated with values that indicate that the DCI message includes a timing advance command, and transmit, to the network entity, an uplink message associated with the timing advance command indicated in the DCI message.

In some examples of the method, apparatuses, and non-transitory computer-readable medium described herein, receiving the DCI message may include operations, features, means, or instructions for receiving an uplink DCI message, where the uplink DCI message indicates the timing advance command instead of scheduling an uplink shared channel message, or activating or releasing a configured grant (CG) configuration.

In some examples of the method, apparatuses, and non-transitory computer-readable medium described herein, receiving the DCI message may include operations, features, means, or instructions for receiving a downlink DCI message, where the downlink DCI message indicates the timing advance command instead of scheduling a downlink shared channel message, or activating or releasing a semi-persistent scheduling (SPS) configuration.

One innovative aspect of the subject matter described in this disclosure can be implemented in a method for wireless communication at a network entity. The method includes transmitting, to a UE, a DCI message including one or more fields associated with scheduling information for a communication between the network entity and the UE, where the DCI message is transmitted in a DCI format that includes an CRC scrambled by a CS-RNTI, the one or more fields being populated with values that indicate that the DCI message includes a timing advance command, and receiving, from the UE, an uplink message associated with the timing advance command indicated in the DCI message.

Another innovative aspect of the subject matter described in this disclosure can be implemented in an apparatus for wireless communication at a network entity. The apparatus includes one or more interfaces configured to output, to a UE, a DCI message including one or more fields associated with scheduling information for a communication between the network entity and the UE, where the DCI message is transmitted in a DCI format that includes an CRC scrambled by a CS-RNTI, the one or more fields being populated with values that indicate that the DCI message includes a timing advance command, and obtain, from the UE, an uplink message associated with the timing advance command indicated in the DCI message.

Another innovative aspect of the subject matter described in this disclosure can be implemented in an apparatus for wireless communication at a network entity. The apparatus includes means for transmitting, to a UE, a DCI message including one or more fields associated with scheduling information for a communication between the network entity and the UE, where the DCI message is transmitted in a DCI format that includes an CRC scrambled by a CS-RNTI, the one or more fields being populated with values that indicate that the DCI message includes a timing advance command and means for receiving, from the UE, an uplink message associated with the timing advance command indicated in the DCI message.

Another innovative aspect of the subject matter described in this disclosure can be implemented in a non-transitory computer-readable medium storing code for wireless communication at a network entity. The code includes instructions executable by a processor to transmit, to a UE, a DCI message including one or more fields associated with scheduling information for a communication between the network entity and the UE, where the DCI message is transmitted in a DCI format that includes an CRC scrambled by a CS-RNTI, the one or more fields being populated with values that indicate that the DCI message includes a timing advance command and receive, from the UE, an uplink message associated with the timing advance command indicated in the DCI message.

In some examples of the method, apparatuses, and non-transitory computer-readable medium described herein, transmitting the DCI message may include operations, features, means, or instructions for transmitting an uplink DCI message, where the uplink DCI message indicates the timing advance command instead of scheduling an uplink shared channel message, or activating or releasing a CG configuration.

In some examples of the method, apparatuses, and non-transitory computer-readable medium described herein, transmitting the DCI message may include operations, features, means, or instructions for transmitting a downlink DCI message, where the downlink DCI message indicates the timing advance command instead of scheduling a downlink shared channel message, or activating or releasing an SPS configuration.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example of a wireless communications system that supports dynamic timing advance (TA) indication in downlink control information (DCI).

FIG. 2 illustrates an example of a network architecture that supports dynamic TA indication in DCI.

FIG. 3 illustrates an example of a signaling diagram that supports dynamic TA indication in DCI.

FIG. 4 illustrates an example of a timing diagram that supports dynamic TA indication in DCI.

FIG. 5 illustrates an example of a timing diagram that supports dynamic TA indication in DCI.

FIG. 6 illustrates an example of a timing diagram that supports dynamic TA indication in DCI.

FIG. 7 illustrates an example of a resource diagram that supports dynamic TA indication in DCI.

FIG. 8 illustrates an example of a resource diagram that supports dynamic TA indication in DCI.

FIG. 9 illustrates an example of a resource diagram that supports dynamic TA indication in DCI.

FIG. 10 illustrates an example of a process flow that supports dynamic TA indication in DCI.

FIG. 11 shows a diagram of a system including a device that supports dynamic TA indication in DCI.

FIG. 12 shows a diagram of a system including a device that supports dynamic TA indication in DCI.

FIGS. 13 and 14 show flowcharts illustrating methods that support dynamic TA indication in DCI.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing third generation (3G), fourth generation (4G) or fifth generation (5G), or further implementations thereof, technology.

In some wireless communications systems, a user equipment (UE) may receive downlink control information (DCI) from multiple transmission and reception points (TRPs), scheduling uplink transmissions (such as physical uplink shared channel (PUSCH) or physical uplink control channel (PUCCH) transmissions) to the multiple TRPs. The UE may differentiate the TRPs according to control resource set (CORESET) pool indices associated with the TRPs. The UE may adjust the timing of an uplink transmission by applying a timing advance (a timing advance (TA) value) to the uplink transmission, meaning that the timing of an uplink transmission may be “advanced” by an amount indicated by a TA value. A UE may apply different TAs to uplink transmissions to the different TRPs. An initial TA value may be indicated in a random access response (RAR) message or an absolute TA command may be indicated in a medium access control (MAC) control element (CE). After the initial TA, the network may indicate additional, incremental, TA adjustments to the UE in TA commands. TA adjustments may be indicated to a UE via a MAC-CE. Indications, via a MAC-CE, however, are not as flexible and may be associated with higher latency as compared to indications via DCI. Currently, however, there is no defined way to include a TA command in a DCI message or to indicate in a DCI message that a DCI message is carrying a TA command. There is also currently no defined way to indicate to which CORESET pool index (such as to which TRP) a TA command in a DCI message applies.

The present disclosure relates to techniques for indicating a TA command in a DCI message. For a DCI message configured to schedule an uplink or downlink communication, one or more fields of the DCI message may be repurposed and populated with values that indicate that the DCI message includes a TA command and the TA command itself. For example, the DCI format may include a cyclic redundancy check (CRC) scrambled by a configured scheduling radio network temporary identifier (CS-RNTI). The UE may communicate an uplink message to the network in accordance with the indicated TA command. Example fields that may be used to indicate that the DCI message includes the TA command, as well as fields that may actually include the TA command, such as the time domain resource allocation (TDRA) field, the hybrid automatic repeat request (HARQ) process number (HPN) field, a frequency hopping flag field, a transmit power control (TPC) field, a PUCCH resource indicator field, or a physical downlink shared channel (PDSCH)-to-HARQ timing indicator field. The DCI message also may indicate a CORESET pool index and component carrier (CC) to which the TA command is applicable. In accordance with the slot in which the DCI message is received, the UE may select, calculate, or determine a later slot at which time the TA command becomes applicable. The TA command may indicate a timing adjustment value relative to a previous TA or an absolute TA value. The DCI message may indicate whether the TA command is a relative or absolute TA adjustment.

Particular implementations of the subject matter described in this disclosure can be implemented to realize one or more of the following potential advantages. As DCI messages are more flexible and faster as compared to a MAC-CE, by using DCI messages to indicate TA commands, TA commands may be more flexible and communicated to the UE in a faster manner as compared to TA commands communicated to the UE via a MAC-CE. DCI messages configured for scheduling communications between the UE and the network may be reused to indicate TA commands by setting given fields to defined values, and accordingly TA commands may be indicated with the speed and flexibility of DCI messages without defining a new type of DCI message.

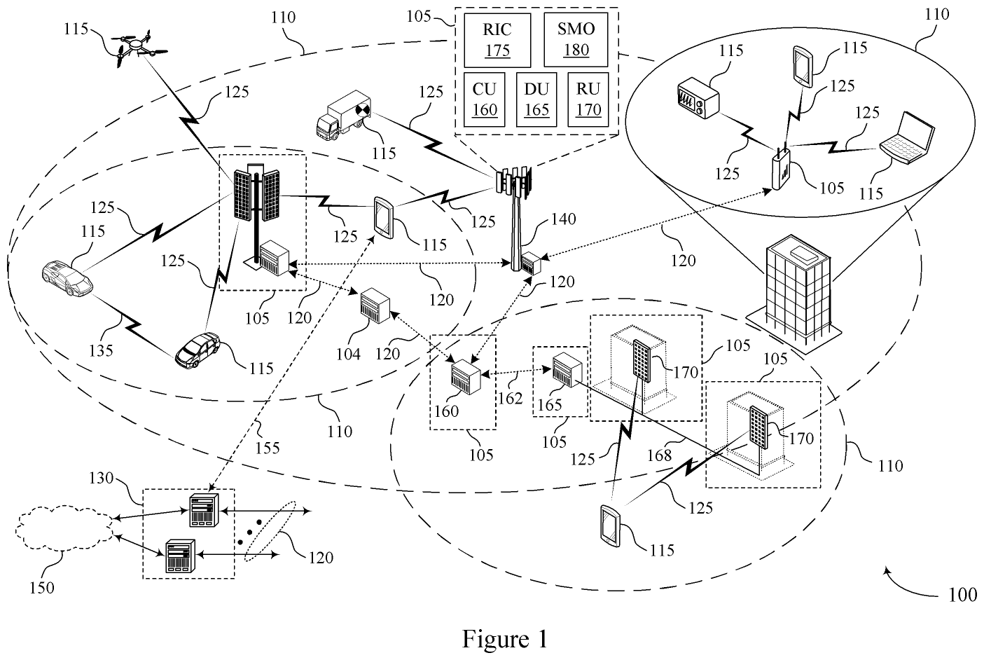

FIG. 1 illustrates an example of a wireless communications system 100 that supports dynamic TA indication in DCI. The wireless communications system 100 may include one or more network entities 105, one or more UEs 115, and a core network 130. In some implementations, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some implementations, network entities 105 and UEs 115 may wirelessly communicate via one or more communication links 125 (such as a radio frequency (RF) access link). For example, a network entity 105 may support a coverage area 110 (such as a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some implementations, network entities 105 may communicate with the core network 130, or with one another, or both. For example, network entities 105 may communicate with the core network 130 via one or more backhaul communication links 120 (such as in accordance with an S1, N2, N3, or other interface protocol). In some implementations, network entities 105 may communicate with one another via a backhaul communication link 120 (such as in accordance with an X2, Xn, or other interface protocol) either directly (such as directly between network entities 105) or indirectly (such as via a core network 130). In some implementations, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication links 120, midhaul communication links 162, or fronthaul communication links 168 may be or include one or more wired links (such as an electrical link, an optical fiber link), one or more wireless links (such as a radio link, a wireless optical link), among other examples or various combinations thereof. A UE 115 may communicate with the core network 130 via a communication link 155.

One or more of the network entities 105 described herein may include or may be referred to as a base station (BS) 140 (such as a base transceiver station, a radio BS, an NR BS, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some implementations, a network entity 105 (such as a BS 140) may be implemented in an aggregated (such as monolithic, standalone) BS architecture, which may be configured to utilize a protocol stack that is physically or logically integrated within a single network entity 105 (such as a single RAN node, such as a BS 140).

In some implementations, a network entity 105 may be implemented in a disaggregated architecture (such as a disaggregated BS architecture, a disaggregated RAN architecture), which may be configured to utilize a protocol stack that is physically or logically distributed among two or more network entities 105, such as an integrated access backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU) 160, a distributed unit (DU) 165, a radio unit (RU) 170, a RAN Intelligent Controller (RIC) 175 (such as a Near-Real Time RIC (Near-RT RIC), a Non-Real Time RIC (Non-RT RIC)), a Service Management and Orchestration (SMO) 180 system, or any combination thereof. An RU 170 also may be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some implementations, one or more network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending upon which functions (such as network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some implementations, the CU 160 may host upper protocol layer (such as layer 3 (L3), layer 2 (L2)) functionality and signaling (such as Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (such as physical (PHY) layer) or L2 (such as radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or more RUs 170). In some implementations, a functional split between a CU 160 and a DU 165, or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (such as F1, F1-c, F1-u), and a DU 165 may be connected to one or more RUs 170 via a fronthaul communication link 168 (such as open fronthaul (FH) interface). In some implementations, a midhaul communication link 162 or a fronthaul communication link 168 may be implemented in accordance with an interface (such as a channel) between layers of a protocol stack supported by respective network entities 105 that are in communication via such communication links.

In wireless communications systems (such as wireless communications system 100), infrastructure and spectral resources for radio access may support wireless backhaul link capabilities to supplement wired backhaul connections, providing an IAB network architecture (such as to a core network 130). In some implementations, in an IAB network, one or more network entities 105 (such as IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (such as a donor BS 140). The one or more donor network entities 105 (such as IAB donors) may be in communication with one or more additional network entities 105 (such as IAB nodes 104) via supported access and backhaul links (such as backhaul communication links 120). IAB nodes 104 may include an IAB mobile termination (IAB-MT) controlled (such as scheduled) by DUs 165 of a coupled IAB donor. An IAB-MT may include an independent set of antennas for relay of communications with UEs 115, or may share the same antennas (such as of an RU 170) of an IAB node 104 used for access via the DU 165 of the IAB node 104 (such as referred to as virtual IAB-MT (vIAB-MT)). In some implementations, the IAB nodes 104 may include DUs 165 that support communication links with additional entities (such as IAB nodes 104, UEs 115) within the relay chain or configuration of the access network (such as downstream). In such implementations, one or more components of the disaggregated RAN architecture (such as one or more IAB nodes 104 or components of IAB nodes 104) may be configured to operate according to the techniques described herein.

For instance, an access network (AN) or RAN may include communications between access nodes (such as an IAB donor), IAB nodes 104, and one or more UEs 115. The IAB donor may facilitate connection between the core network 130 and the AN (such as via a wired or wireless connection to the core network 130). That is, an IAB donor may refer to a RAN node with a wired or wireless connection to core network 130. The IAB donor may include a CU 160 and at least one DU 165 (such as and RU 170), for which the CU 160 may communicate with the core network 130 via an interface (such as a backhaul link). IAB donor and IAB nodes 104 may communicate via an F1 interface according to a protocol that defines signaling messages (such as an F1 AP protocol). Additionally, or alternatively, the CU 160 may communicate with the core network via an interface, which may be an example of a portion of backhaul link, and may communicate with other CUs 160 (such as a CU 160 associated with an alternative IAB donor) via an Xn-C interface, which may be an example of a portion of a backhaul link.

An IAB node 104 may refer to a RAN node that provides IAB functionality (such as access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (such as an IAB donor may relay transmissions for UEs through one or more other IAB nodes 104). Additionally, or alternatively, an IAB node 104 also may be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (such as DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (such as a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (such as transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the implementation of the techniques described herein applied in the context of a disaggregated RAN architecture, one or more components of the disaggregated RAN architecture may be configured to support dynamic TA indication in DCI as described herein. For example, some operations described as being performed by a UE 115 or a network entity 105 (such as a BS 140) may additionally, or alternatively, be performed by one or more components of the disaggregated RAN architecture (such as IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay BSs, among other examples, as shown in FIG. 1.

The UEs 115 and the network entities 105 may wirelessly communicate with one another via one or more communication links 125 (such as an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (such as a bandwidth part (BWP)) that is operated according to one or more physical layer channels for a given radio access technology (such as LTE, LTE-A, LTE-A Pro, NR). Each physical layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a BS 140, a CU 160, a DU 165, a RU 170) of a RAN communicating with another device (such as directly or via one or more other network entities 105).

In some implementations, such as in a carrier aggregation configuration, a carrier also may have acquisition signaling or control signaling that coordinates operations for other carriers. A carrier may be associated with a frequency channel (such as an evolved universal mobile telecommunication system terrestrial radio access (E-UTRA) absolute RF channel number (EARFCN)) and may be identified according to a channel raster for discovery by the UEs 115. A carrier may be operated in a standalone mode, for which initial acquisition and connection may be conducted by the UEs 115 via the carrier, or the carrier may be operated in a non-standalone mode, for which a connection is anchored using a different carrier (such as of the same or a different radio access technology).

The communication links 125 shown in the wireless communications system 100 may include downlink transmissions (such as forward link transmissions) from a network entity 105 to a UE 115, uplink transmissions (such as return link transmissions) from a UE 115 to a network entity 105, or both, among other configurations of transmissions. Carriers may carry downlink or uplink communications (such as in an FDD mode) or may be configured to carry downlink and uplink communications (such as in a TDD mode).

A carrier may be associated with a particular bandwidth of the RF spectrum and, in some implementations, the carrier bandwidth may be referred to as a “system bandwidth” of the carrier or the wireless communications system 100. For example, the carrier bandwidth may be one of a set of bandwidths for carriers of a particular radio access technology (such as 1.4, 3, 5, 10, 15, 20, 40, or 80 megahertz (MHz)). Devices of the wireless communications system 100 (such as the network entities 105, the UEs 115, or both) may have hardware configurations that support communications using a particular carrier bandwidth or may be configurable to support communications using one of a set of carrier bandwidths. In some implementations, the wireless communications system 100 may include network entities 105 or UEs 115 that support concurrent communications using carriers associated with multiple carrier bandwidths. In some implementations, each served UE 115 may be configured for operating using portions (such as a sub-band, a BWP) or all of a carrier bandwidth.

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, for which the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some implementations, a UE 115 may be configured with multiple BWPs. In some implementations, a single BWP for a carrier may be active at a given time and communications for the UE 115 may be restricted to one or more active BWPs.

The time intervals for the network entities 105 or the UEs 115 may be expressed in multiples of a basic time unit which may, in some implementations, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (such as 10 milliseconds (ms)). Each radio frame may be identified by a system frame number (such as ranging from 0 to 1023).

Each frame may include multiple consecutively numbered subframes or slots, and each subframe or slot may have the same duration. In some implementations, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some implementations, the TTI duration (such as a quantity of symbol periods in a TTI) may be variable. Additionally, or alternatively, the smallest scheduling unit of the wireless communications system 100 may be dynamically selected (such as in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (such as using a carrier) and may be associated with an identifier for distinguishing neighboring cells (such as a physical cell identifier (PCID), a virtual cell identifier (VCID), or others). In some implementations, a cell also may refer to a coverage area 110 or a portion of a coverage area 110 (such as a sector) over which the logical communication entity operates. Such cells may range from smaller areas (such as a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (such as several kilometers in radius) and may allow unrestricted access by the UEs 115 with service subscriptions with the network provider supporting the macro cell. A small cell may be associated with a lower-powered network entity 105 (such as a lower-powered BS 140), as compared with a macro cell, and a small cell may operate using the same or different (such as licensed, unlicensed) frequency bands as macro cells. Small cells may provide unrestricted access to the UEs 115 with service subscriptions with the network provider or may provide restricted access to the UEs 115 having an association with the small cell (such as the UEs 115 in a closed subscriber group (CSG), the UEs 115 associated with users in a home or office). A network entity 105 may support one or multiple cells and also may support communications via the one or more cells using one or multiple CCs.

In some implementations, a carrier may support multiple cells, and different cells may be configured according to different protocol types (such as MTC, narrowband IoT (NB-IoT), enhanced mobile broadband (eMBB)) that may provide access for different types of devices.

In some implementations, a network entity 105 (such as a BS 140, an RU 170) may be movable and therefore provide communication coverage for a moving coverage area 110. In some implementations, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (such as BSs 140) may have similar frame timings, and transmissions from different network entities 105 may be approximately aligned in time. For asynchronous operation, network entities 105 may have different frame timings, and transmissions from different network entities 105 may, in some implementations, not be aligned in time. The techniques described herein may be used for either synchronous or asynchronous operations.

Some UEs 115, such as MTC or IoT devices, may be low cost or low complexity devices and may provide for automated communication between machines (such as via Machine-to-Machine (M2M) communication). M2M communication or MTC may refer to data communication technologies that allow devices to communicate with one another or a network entity 105 (such as a BS 140) without human intervention. In some implementations, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (such as a mode that supports one-way communication via transmission or reception, but not transmission and reception concurrently). In some implementations, half-duplex communications may be performed at a reduced peak rate. Other power conservation techniques for the UEs 115 include entering a power saving deep sleep mode when not engaging in active communications, operating using a limited bandwidth (such as according to narrowband communications), or a combination of these techniques. For example, some UEs 115 may be configured for operation using a narrowband protocol type that is associated with a defined portion or range (such as set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some implementations, a UE 115 may be configured to support communicating directly with other UEs 115 via a device-to-device (D2D) communication link 135 (such as in accordance with a peer-to-peer (P2P), D2D, or sidelink protocol). In some implementations, one or more UEs 115 of a group that are performing D2D communications may be within the coverage area 110 of a network entity 105 (such as a BS 140, an RU 170), which may support aspects of such D2D communications being configured by (such as scheduled by) the network entity 105. In some implementations, one or more UEs 115 of such a group may be outside the coverage area 110 of a network entity 105 or may be otherwise unable to or not configured to receive transmissions from a network entity 105. In some implementations, groups of the UEs 115 communicating via D2D communications may support a one-to-many (1:M) system in which each UE 115 transmits to each of the other UEs 115 in the group. In some implementations, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (such as UEs 115). In some implementations, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some implementations, vehicles in a V2X system may communicate with roadside infrastructure, such as roadside units, or with the network via one or more network nodes (such as network entities 105, BSs 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as BSs 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communication using UHF waves may be associated with smaller antennas and shorter ranges (such as less than 100 kilometers) compared to communications using the smaller frequencies and longer waves of the high frequency (HF) or very high frequency (VHF) portion of the spectrum below 300 MHz.

The wireless communications system 100 also may operate using a super high frequency (SHF) region, which may be in the range of 3 GHz to 30 GHz, also known as the centimeter band, or using an extremely high frequency (EHF) region of the spectrum (such as from 30 GHz to 300 GHz), also known as the millimeter band. In some implementations, the wireless communications system 100 may support millimeter wave (mmW) communications between the UEs 115 and the network entities 105 (such as BSs 140, RUs 170), and EHF antennas of the respective devices may be smaller and more closely spaced than UHF antennas. In some implementations, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some implementations, operations using unlicensed bands may be based on a carrier aggregation configuration in conjunction with CCs operating using a licensed band (such as LAA). Operations using unlicensed spectrum may include downlink transmissions, uplink transmissions, P2P transmissions, or D2D transmissions, among other examples.

A network entity 105 (such as a BS 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (such as the same codeword) or different data streams (such as different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which also may be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

A network entity 105 or a UE 115 may use beam sweeping techniques as part of beamforming operations. For example, a network entity 105 (such as a BS 140, an RU 170) may use multiple antennas or antenna arrays (such as antenna panels) to conduct beamforming operations for directional communications with a UE 115. Some signals (such as synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (such as by a transmitting device, such as a network entity 105, or by a receiving device, such as a UE 115) a beam direction for later transmission or reception by the network entity 105.

Some signals, such as data signals associated with a particular receiving device, may be transmitted by transmitting device (such as a transmitting network entity 105, a transmitting UE 115) along a single beam direction (such as a direction associated with the receiving device, such as a receiving network entity 105 or a receiving UE 115). In some implementations, the beam direction associated with transmissions along a single beam direction may be selected, calculated, or determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some implementations, transmissions by a device (such as by a network entity 105 or a UE 115) may be performed using multiple beam directions, and the device may use a combination of digital precoding or beamforming to generate a combined beam for transmission (such as from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (such as a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (such as a multi-panel type codebook, a linear combination type codebook, a port selection type codebook). Although these techniques are described with reference to signals transmitted along one or more directions by a network entity 105 (such as a BS 140, an RU 170), a UE 115 may employ similar techniques for transmitting signals multiple times along different directions (such as for identifying a beam direction for subsequent transmission or reception by the UE 115) or for transmitting a signal along a single direction (such as for transmitting data to a receiving device).

A receiving device (such as a UE 115) may perform reception operations in accordance with multiple receive configurations (such as directional listening) when receiving various signals from a receiving device (such as a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (such as different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some implementations, a receiving device may use a single receive configuration to receive along a single beam direction (such as when receiving a data signal). The single receive configuration may be aligned along a beam direction selected, calculated, or determined based on listening according to different receive configuration directions (such as a beam direction selected, calculated, or determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (such as a communication link 125, a D2D communication link 135). HARQ may include a combination of error detection (such as using a CRC), forward error correction (FEC), and retransmission (such as automatic repeat request (ARQ)). HARQ may improve throughput at the MAC layer in poor radio conditions (such as low signal-to-noise conditions). In some implementations, a device may support same-slot HARQ feedback, for which the device may provide HARQ feedback in a specific slot for data received via a previous symbol in the slot. In some other examples, the device may provide HARQ feedback in a subsequent slot, or according to some other time interval.

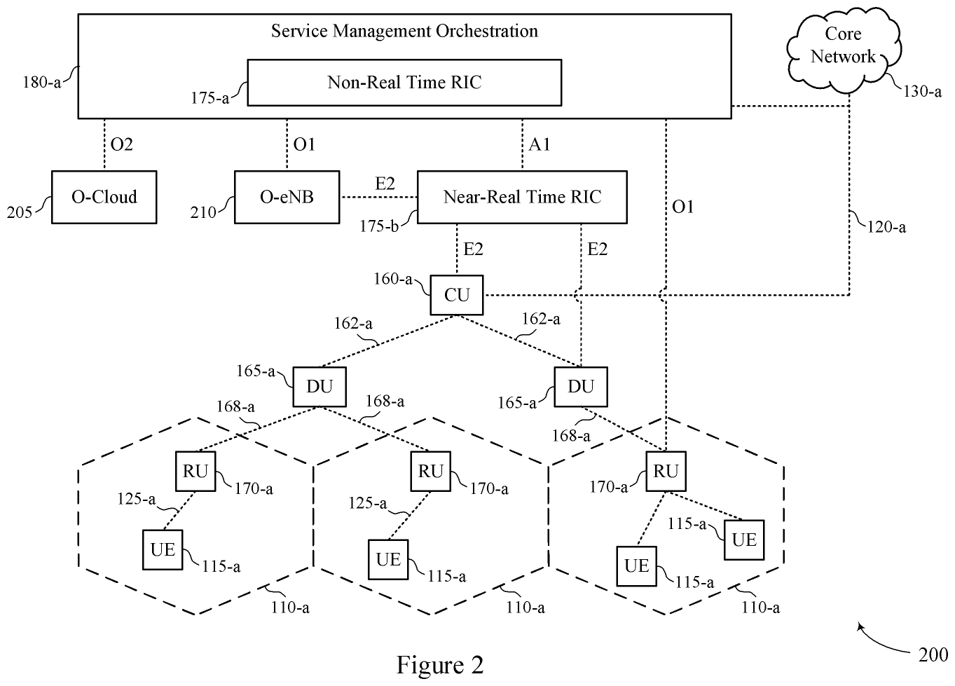

FIG. 2 illustrates an example of a network architecture 200 (such as a disaggregated BS architecture, a disaggregated RAN architecture) that supports per-TRP power control parameters. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (such as a Near-RT RIC 175-b via an E2 link, or a Non-RT RIC 175-a associated with an SMO 180-a (such as an SMO Framework), or both). A CU 160-a may communicate with one or more DUs 165-a via respective midhaul communication links 162-a (such as an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (such as CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (such as data, information) via a wired or wireless transmission medium. Each network entity 105, or an associated processor (such as controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (such as an RF transceiver) configured to receive or transmit signals, or both, over a wireless transmission medium to one or more of the other network entities 105.

In some implementations, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (such as CU-UP), control plane functionality (such as CU-CP), or a combination thereof. In some implementations, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (such as BS functions, RAN functions) to control the operation of one or more RUs 170-a. In some implementations, a DU 165-a may host, at least partially, one or more of an RLC layer, a MAC layer, and one or more aspects of a PHY layer (such as a high PHY layer, such as modules for FEC encoding and decoding, scrambling, modulation and demodulation, or the like) depending, at least in part, on a functional split, such as those defined by the 3rd Generation Partnership Project (3GPP). In some implementations, a DU 165-a may further host one or more low PHY layers. Each layer may be implemented with an interface configured to communicate signals with other layers hosted by the DU 165-a, or with control functions hosted by a CU 160-a.

In some implementations, lower-layer functionality may be implemented by one or more RUs 170-a. For example, an RU 170-a, controlled by a DU 165-a, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some implementations, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (such as an O1 interface). For virtualized network entities 105, the SMO 180-a may be configured to interact with a cloud computing platform (such as an O-Cloud 205) to perform network entity life cycle management (such as to instantiate virtualized network entities 105) via a cloud computing platform interface (such as an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (such as via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (such as via an A1 interface) the Near-RT RIC 175-b. The Near-RT RIC 175-b may be configured to include a logical function that enables near-real-time control and optimization of RAN elements and resources via data collection and actions over an interface (such as via an E2 interface) connecting one or more CUs 160-a, one or more DUs 165-a, or both, as well as an O-eNB 210, with the Near-RT RIC 175-b.

In some implementations, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some implementations, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (such as reconfiguration via O1) or via generation of RAN management policies (such as A1 policies).

In some implementations, a UE 115-a may communicate with the network via multiple TRPs (such as the UE 115-a may operate in a multiple TRP mode). As described herein, a TRP may include an RU 170-a, a DU 165-a, or a combination thereof.

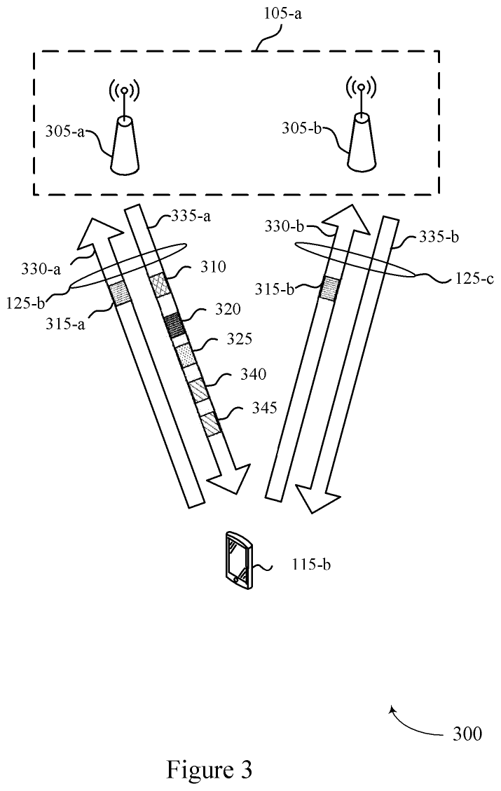

FIG. 3 illustrates an example of a signaling diagram 300 that supports dynamic TA indication in DCI. In some implementations, the signaling diagram 300 may implement aspects of wireless communications system 100. The signaling diagram 300 may include a UE 115-b, which may be an example of a UE 115 as described herein. The signaling diagram 300 may include a network entity 105-a, which may be an example of a network entity 105 as described herein.

The UE 115-b may operate in a multiple TRP mode with a first TRP 305-a and a second TRP 305-b. In some implementations, the first TRP 305-a and the second TRP 305-b may be located at a same network entity 105-a. In some implementations, the first TRP 305-a and the second TRP 305-b may be located at different network entities.

The UE 115-b may communicate with the first TRP 305-a and the second TRP 305-b. In some implementations, the UE 115-b may be capable of communicating simultaneously with the first TRP 305-a and the second TRP 305-b (such as using a same set of time resources, or a same set of frequency resource, or both, but different spatial resources). The UE 115-b may communicate with the first TRP 305-a using a communication link 125-b. The UE 115-b may communicate with the second TRP 305-b using a communication link 125-c. The communication link 125-b and the communication link 125-c may include bi-directional links that enable both uplink and downlink communication. For example, the UE 115-b may transmit uplink signals 330-a, such as uplink control signals or uplink data signals, to the first TRP 305-a using the communication link 125-b and the first TRP 305-a may transmit downlink signals 335-a, such as downlink control signals or downlink data signals, to the UE 115-b using the communication link 125-b. The UE 115-b may transmit uplink signals 330-b, such as uplink control signals or uplink data signals, to the second TRP 305-b using the communication link 125-c and the second TRP 305-b may transmit downlink signals 335-b, such as downlink control signals or downlink data signals, to the UE 115-b using the communication link 125-c. In some implementations, different TRPs (such as the first TRP 305-a and the second TRP 305-b) may have different TRP identifiers. In some implementations, different TRPs may be identified through an association with other identifiers, such as a CORESET pool index, closed loop index, transmission configuration indicator (TCI) identifier, TCI group identifier, or a sounding reference signal resource set identifier.

The UE 115-b may support multi-DCI based multi-TRP transmission operations. In a multi-DCI based multi-TRP operation, a first DCI message (transmitted from the first TRP 305-a) may schedule a first PDSCH transmitted from the first TRP 305-a via the communication link 125-b, and a second DCI message (transmitted from the second TRP 305-b) may schedule a second PDSCH transmitted from the second TRP 305-b via the communication link 125-c. TRP differentiation at the UE side may be associated with a CORESET pool index. Each CORESET (of a maximum 5 coresets) may be configured with a value of the parameter CORESETPoolIndex, which may be “0” or “1”. Accordingly, CORESETs may be grouped into two groups. Aside from the CORESET pool index, the TRPs (the first TRP 305-a and the second TRP 305-b) may be transparent to the UE 115-b. The UE 115-d may be configured with multi-DCI based multi-TRP operation in a given CC.

In some implementations, a UE may be configured by the higher layer parameter PDC CH-Config that includes two different values of the parameter CORESETPoolIndex in CORESETs for the active BWP of the serving cell. For example, the CORESETPoolIndex=“0” may include a CORESET identifier equal to “1” and a CORESET identifier equal to “2,” and the CORESETPoolIndex=“1” may include a CORESET identifier equal to “3” and a CORESET identifier equal to “4.” The CORESETPoolIndex of the CORESET in which a DCI is received may be used for different purposes, for example HARQ feedback.

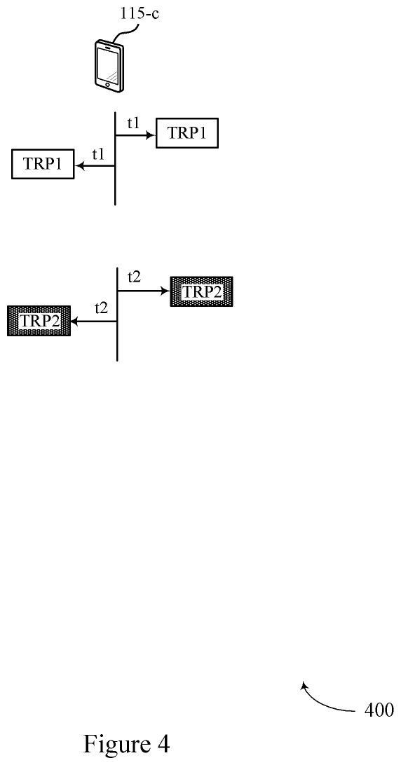

In some implementations, each serving cell may be associated with one TA group (TAG). In some implementations, for example as described with reference to FIG. 4, two TA values for uplink multi-DCI multi-TRP operation may be specified. For example, two TAGs may be specified, and each TRP may be associated with a different TAG.

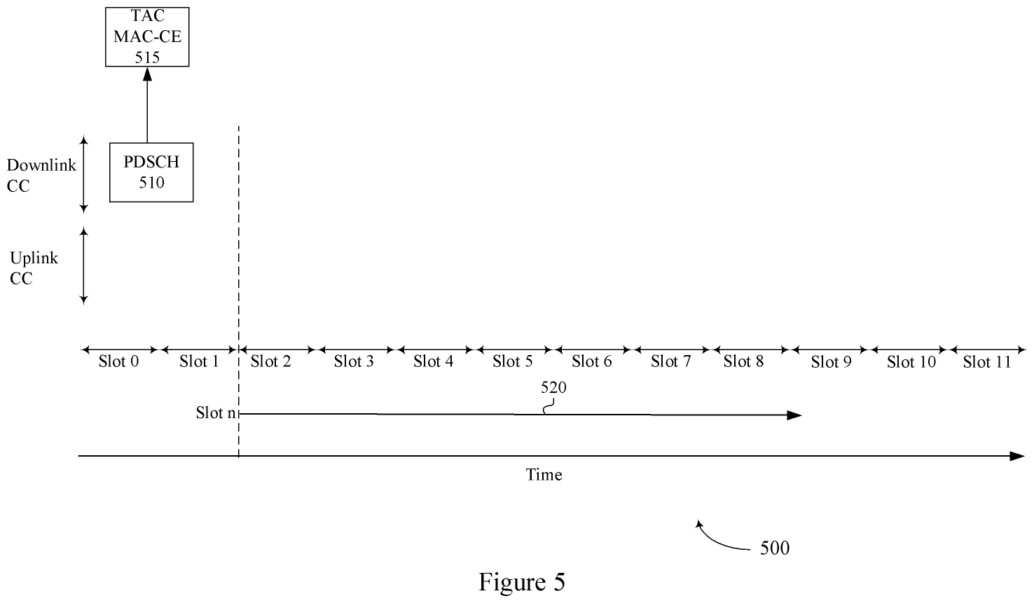

In some implementations, an initial TA value for an uplink transmission 315 may be indicated by a RAR 310 PDSCH transmission or an absolute MAC-CE 320 command. The TA may be a positive absolute value in the range TA=0, 1, 2, . . . , 3846. The value of the TA may be converted to a time offset as NTA=TA·16·64/2^{μ}. N_{TA} may be relative to the subcarrier spacing of the first uplink transmission from the UE 115-b after the reception of the RAR 310 PDSCH or the absolute TA command MAC-CE 320. After the first TA command, the network entity 105-a may transmit TA adjustment values (such as to adjust for changes in location of the UE 115-b or channel conditions). TA adjustment values may be indicated via a MAC-CE 320. The MAC-CE 320 may indicate a TAG identifier. The adjustment of the current N_{TA} value (N_{TA_old}) to the new N_{TA} value (N_{TA_new}) may be indicated in the MAC-CE 320 by index values of TA=0, 1, 2, . . . , 63, where for a subcarrier spacing of 2^{μ}·15 kHz, N_{TA_new}=N_{TA_old}+(T_{A}−31)·16·64/2^{μ}. For a TA command received on uplink slot n and for a transmission other than a PUSCH scheduled by a RAR 310 including an uplink grant, a fallback RAR 310 including an uplink grant, or a PUCCH with HARQ acknowledgement (ACK) information in response to a successful RAR 310, the corresponding adjustment of the uplink transmission timing may apply from the beginning of uplink slot n+k+1+2^{μ}·K_{offset} where k=┌Nₛₗₒₜ^{subframe,μ}·(N_{T,1}+N_{T,2}+N_{TA,max}+0.5)/T_{sf}┐. N_{T,1} refers to a time duration in milliseconds of N₁ symbols corresponding to a PDSCH processing time for the UE 115-b processing capability 1 when an additional PDSCH demodulation reference signal is configured. N_{T,2} refers to a time duration in milliseconds of N₂ symbols corresponding to a PUSCH preparation time for the UE 115-b processing capability 1. N₁ and N₂ may be selected, calculated, or determined with respect to the minimum subcarrier spacing among the subcarrier spacings of all configured uplink BWPs for all uplink carriers in the TAG and of all configured downlink BWPs for the corresponding downlink carriers. For μ=0, the UE 115-b may assume N_{1,0}=14. N_{TA,max} refers to the maximum TA value in milliseconds that can be provided by a TA command field of 12 bits, and N_{TA,max} may be selected, calculated, or determined with respect to the minimum subcarrier spacing among the subcarrier spacings of all configured uplink BWPs for all uplink carriers in the TAG and for all configured initial uplink BWPs provided by the parameter initialUplinkBWP. Nₛₗₒₜ^{subframe,μ} may refer to a number of slots per subframe, T_{sf} may refer to the subframe duration of 1 millisecond. Slot n and Nₛₗₒₜ^{subframe,μ} may be selected, calculated, or determined with respect to the minimum subcarrier spacing among the subcarrier spacings of all configured uplink BWPs for all uplink carriers in the TAG. K_{offset}=K_{cell,offset}−K_{UE,offset}, where K_{cell,offset} is provided by Koffset in ServingCellConfigCommon and K_{UE,offset} is provided by a MAC CE command; otherwise, if not respectively provided, K_{cell,offset}=0 or K_{UE,offset}=0. The uplink slot n refers to the last slot among uplink slot(s) overlapping with the slot(s) of PDSCH reception assuming T_{TA}=0, where the PDSCH provides the TA command, and T_{TA} may be a defined value known by the UE 115-b and the network entity 105-a. An example illustration of a TA application time is described herein with reference to FIG. 5.

In some implementations, a dedicated DCI messages 325 may indicate a TA adjustment value for a given TRP (such as the first TRP 305-a or the second TRP 305-b). For example, when a UE 115-b receives a TA command in a DCI message 325, the UE 115-b may adjust uplink transmission timing associated with the given TRP by a corresponding TA adjustment value. For example, the TA adjustment value range may be [−31·16·64/2^{μ}, 32·16·64/2^{μ}]. In another example, a TA command in a MAC-CE 320 may indicate timing adjustment values for the uplink transmissions 315-a to the first TRP 305-a, and a TA command in a DCI message may indicate an offset value between the TA adjustment value for the uplink transmissions 315-b to the second TRP 305-b and the TA adjustment value for the first TRP 305-a. For example, a MAC-CE 320 may indicate a TA adjustment index value T_{A} for the uplink transmissions 315-a to the first TRP 305-a, and a DCI message 325 may indicate an offset value Δ_{offset}, and the TA adjustment value for the uplink transmissions 315-b to the second TRP 305-b may be (T_{A}−31)·16·64/2^{μ}+Δ_{offset}. As another example, a TA command in a DCI message 325 may indicate an offset value between a currently maintained TA for one TRP (such as the first TRP 305-a) and an expected TA for another TRP (such as the second TRP 305-b). For example, the TA for the uplink transmissions 315-a to the first TRP 305-a may be maintained to be N_{TA1}, and when the UE 115-b receives a TA command with index value T_{TA,offset} for the uplink transmissions 315-b to the second TRP 305-b in a DCI message 325, the TA for the second TRP 305-b may be calculated as N_{TA2}=N_{TA1}+T_{TA,offset}·16·64/2^{μ}, and T_{TA,offset} may be positive or negative. Assuming the maximum uplink timing difference for inter-band carrier aggregation is applied for multi-DCI based multi-TRP operation, the range of T_{TA,offset} may be [−66·2^{μ}, 66·2^{μ}] for frequency range 1 (FR1) (34.6 us) and [−16·2^{μ}, 16·2^{μ}] for frequency range 2 (FR2) (8.5 us).

For multi-DCI based multi-TRP operation, the TA command in a dedicated DCI message 325 may indicate the TA adjustment value for a given CORESETPoolIndex value, the TA adjustment offset value with respect to the TA adjustment offset of a reference CORESETPoolIndex value (such as the TA adjustment value for the uplink transmissions 315 associated with the reference CORESETPoolIndex value may be indicated via a MAC-CE 320), or the TA offset value with respect to a TA value of a reference CORESETPoolIndex value (such as the TA value of a of a reference CORESETPoolIndex value may be indicated via a MAC-CE 320).

DCI messages may be faster and more flexible as compared to MAC-CE. Additionally, the application of a TA indication of a DCI message for an uplink channel may be selected, calculated, ascertained, or determined at the UE 115-b in accordance with the CORESETPoolIndex of the CORESET in which the DCI message is received. One issue, however, is how to indicate that a DCI message includes a TA command.

In some implementations, an uplink DCI message 340 or a downlink DCI message 345 (such as a DCI message having a number of fields configured to indicate scheduling information for an uplink or downlink transmission, respectively) may be reused to indicate a TA command. For example, the uplink DCI message 340 or the downlink DCI message 345 may include a CRC scrambled by a CS-RNTI.

For example, an uplink DCI message 340 (fallback or non-fallback) that may be used to indicate a TA command may not schedule a PUSCH or may not activate or release a configured grant (CG). For an uplink DCI message 340, the CS-RNTI may be used for CRC scrambling. Given fields of the uplink DCI message 340 may be set to indicate the uplink DCI message 340 carries a TA command. For example, the redundancy version (RV) fields may all be set to “1”s, the modulation and control scheme (MCS) fields may all be set to “1”s, the new data indicator (NDI) field may be set to “0”. The frequency domain resource assignment (FDRA) fields may be set to all “0”s for type 0 or dynamic switch FDRA, or all “1”'s for FDRA type 1. The RV, MCS, NDI, and FDRA fields may be used to indicate that the uplink DCI message 340 includes a TA command as the RV, MCS, NDI and FDRA fields are not used for uplink scheduling. The TA command itself in an uplink DCI message 340 may be indicated using one or more of the TDRA field (which includes 4 bits), the HPN field (which includes 4 bits), the frequency hopping flag field (which includes 1 bit), or the TPC field (which includes 2 bits).

As another example, a downlink DCI message 345 (fallback or non-fallback) that may be used to indicate a TA command may not schedule a PDSCH or may not activate or release a semi-persistent scheduling (SPS) PDSCH. For a downlink DCI message 345, the CS-RNTI may be used for CRC scrambling. Given fields of the downlink DCI message 345 may be set to indicate the downlink DCI message carries a TA command. For example, the RV fields may all be set to “1”s, the MCS fields may all be set to “1”s, the NDI field may be set to “0”. The FDRA fields may be set to all “0”s for type 0 or dynamic switch FDRA, or all “1”s for FDRA type 1. Additionally, the HPN field may be set to all “1”s to distinguish that the downlink DCI message 345 is used for a TA command and not a unified TCI state. The TA command itself in an downlink DCI message 345 may be indicated using one or more of the TDRA field, the TPC command for a scheduled PUCCH (which includes 2 bits), a PUCCH resource indicator (which includes 3 bits), or the PDSCH-to-HARQ feedback timing indicator (which includes 3 bits).

In some implementations, a TAG identifier may be included in the TA command in the DCI message (the uplink DCI message 340 or the downlink DCI message 345), and the TA command in the DCI message (the uplink DCI message 340 or the downlink DCI message 345) may be applied to the CC(s) which are configured with the same TAG identifier as the indicated TAG identifier. For example, in some implementations, a single TA may be applied per CC. In some implementations, multiple TAs may be applied per CC, where each CC is configured with multiple TAG identifiers. In such implementations, where each CC is configured with multiple TAG identifiers, if a CC is configured with multiple CORESETPoolIndex values (such as multi-DCI based Multi-TRP operation), the TA command may be applied to the uplink transmission 315 that is associated with the same CORESETPoolIndex value that is associated with the indicated TAG identifier. In some implementations, multiple TAs may be applied per each CC, where each CC is configured with a single TAG identifier. In such implementations, where multiple TAs may be applied per each CC, and where each CC is configured with a single TAG identifier, if a CC is configured with multiple CORESETPoolIndex values (such as multi-DCI based Multi-TRP operation), the TA command may be applied to the uplink transmission 315 associated with the same CORESETPoolIndex value that is associated with the CORESET in which the uplink DCI message 340 or the downlink DCI message 345 is received.

In some implementations, the CC(s) to which the TA applies may be selected, calculated, ascertained, or determined using the carrier indicator field (CIF) in the DCI message (the uplink DCI message 340 or the downlink DCI message 345). If the CIF is present in the DCI message (the uplink DCI message 340 or the downlink DCI message 345), the CIF indicates a CC, and the TA command may be applied to the TAG identifier that is configured for the indicated CC. If the CIF is not present in the uplink DCI message 340 or the downlink DCI message 345 (such as in implementations with no cross-carrier scheduling or for fallback DCI), the TA command may be applied to the TAG identifier that is configured for a default uplink CC. The default uplink CC may be assumed as the uplink CC that is associated with the downlink CC in which the DCI message (the uplink DCI message 340 or the downlink DCI message 345) is received. In implementations where a CC is configured with multiple CORESETPoolIndex values and multiple TAG identifiers, the TA command may be applied to the TAG identifier that is associated with the same CORESETPoolIndex value that is associated with the CORESET in which the DCI message (the uplink DCI message 340 or the downlink DCI message 345) is received. In implementations where a CC is configured with multiple CORESETPoolIndex values and a single TAG (but multiple TAs are supported), the TA command may be applied to the uplink transmission 315 that is associated with the same CORESETPoolIndex value that is associated with the CORESET in which the DCI message (the uplink DCI message 340 or the downlink DCI message 345) is received.

For a TA command received in a DCI message (the uplink DCI message 340 or the downlink DCI message 345) received in an uplink slot n, and for a transmission other than: a PUSCH scheduled by a RAR uplink grant or a fallback RAR uplink grant; or a PUCCH with HARQ-ACK information in response to a successful RAR, the corresponding adjustment of the uplink transmission 315 applies from the beginning of the uplink slot n+k+1+2^{μ}·K_{offset} where k=┌Nₛₗₒₜ^{subframe,μ}·(N_{T,1}+N_{T,2}+N_{TA,max}+0.5)/T_{sf}┐. N_{T,1} refers to a time duration in milliseconds of N symbols corresponding to a SPS PDSCH release processing time for UE 115-b processing capability 1. N_{T,2} refers to a time duration in milliseconds of N₂ symbols corresponding to a PUSCH preparation time for the UE 115-b processing capability. N and N₂ may be selected, calculated, or determined with respect to the minimum subcarrier spacing among the subcarrier spacings of all configured uplink BWPs for all uplink carriers in the TAG and of all configured downlink BWPs for the corresponding downlink carriers. N_{TA,max} refers to the maximum TA value in milliseconds that may be provided by a TA command field of 12 bits, and may be selected, calculated, or determined with respect to the minimum subcarrier spacing among the subcarrier spacings of all configured uplink BWPs for all uplink carriers in the TAG and for all configured initial uplink BWPs provided by the parameter initialUplinkBWP. Nₛₗₒₜ^{subframe,μ} refers to the number of slots per subframe. T_{sf} refers to a subframe duration of 1 msec. Slot n and Nₛₗₒₜ^{subframe,μ} may be selected, calculated, or determined with respect to the minimum subcarrier spacing among the subcarrier spacings of all configured uplink BWPs for all uplink carriers in the TAG. K_{offset}=K_{cell,offset}−K_{UE,offset}, where K_{cell,offset} is provided by Koffset in the field ServingCellConfigCommon and K_{UE,offset} is provided by a MAC-CE command. If K_{cell,offset} and K_{UE,offset} are not respectively provided, K_{cell,offset}=0 or K_{UE,offset}=0. In some implementations, the uplink slot n may be selected, calculated, ascertained, or determined based on the last slot among uplink slot(s) overlapping with the slot(s) of physical downlink control channel (PDCCH) reception assuming T_{TA}=0, where the PDCCH provides the TA command and T_{TA} may be a defined value known by the UE 115-b and the network entity 105-a. In some implementations, the uplink slot n may be selected, calculated, ascertained or determined based on the last slot among uplink slot(s) overlapping with the symbol(s) of PDCCH reception assuming T_{TA}=0, where the PDCCH provides the TA command and T_{TA} may be a defined value known by the UE 115-b and the network entity 105-a.

In some implementations, the UE 115-b may be configured with multiple CORESETPoolIndex values, and to select, calculate, or determine the TA value for a given uplink transmission 315, one of the following options may be indicated by the DCI message (the uplink DCI message 340 or the downlink DCI message 345) that includes the TA command, (1) the timing adjustment value for a given CORESETPoolIndex value, (2) the timing adjustment offset value with respect to the timing adjustment offset of a reference CORESETPoolIndex value, or (3) the TA offset value with respect to a TA value of a reference CORESETPoolIndex value.

FIG. 4 illustrates an example of a timing diagram 400 that supports dynamic TA indication in DCI. In some implementations, the timing diagram 400 may implement aspects of wireless communications system 100 or the signaling diagram 300. For example, the timing diagram 400 may include a UE 115-c, which may be an example of a UE 115 as described herein. The TRP1 and TRP2 may be examples of the first TRP 305-a and the second TRP 305-b, as described with reference to FIG. 3.

In some implementations, separate uplink timing may be applied for a multi-TRP deployment, where a first TA value (such as t1) is applied for communications between the UE 115-c and the TRP 1, and a second TA value (such as t2) is applied for communications between the UE 115-c and the TRP2. Accordingly, two TAs may be specified, and each TRP (the TRP1 and the TRP2) may have different TA values (such as specified via TAG values).

FIG. 5 illustrates an example of a timing diagram 500 that supports dynamic TA indication in DCI. In some implementations, the timing diagram 500 may implement aspects of wireless communications system 100 or the signaling diagram 300.

A UE 115 may operate according to a multi-DCI multi-TRP operation, as described herein. The UE 115 may operate with a downlink subcarrier spacing of 15 kHz and an uplink subcarrier spacing of 30 kHz with a K_{offset}=0. In this implementation, the reference subcarrier spacing for N₁ and N₂ may be 15 kHz, which corresponds to N₁=14 symbols, N₂=10 symbols and N_{T,1}=1 ms, N_{T,2}=0.71 ms. The reference subcarrier spacing for N_{TA,max} may be 30 kHz, which corresponds to N_{TA,max}=1 ms. The reference subcarrier spacing for slot n and Nₛₗₒₜ^{subframe,μ} may be 30 kHz, which corresponds to Nₛₗₒₜ^{subframe,μ}=2. k=┌Nₛₗₒₜ^{subframe,μ}·(N_{T,1}+N_{T,2}+N_{TA,max}+0.5)/T_{sf}┐=7. Accordingly, when the UE 115 receives, over a downlink slot which overlaps with uplink slot 0 and slot 1, a PDSCH 510 carrying a MAC-CE with a TA command 515, slot 1 may correspond to the slot n. The offset 520 after which the TA command applies may be calculated as k+1+2^{μ}·K_{offset}=8 slots. Accordingly, the TA command 515 received in slot 0 and slot 1 would first apply in slot 9.

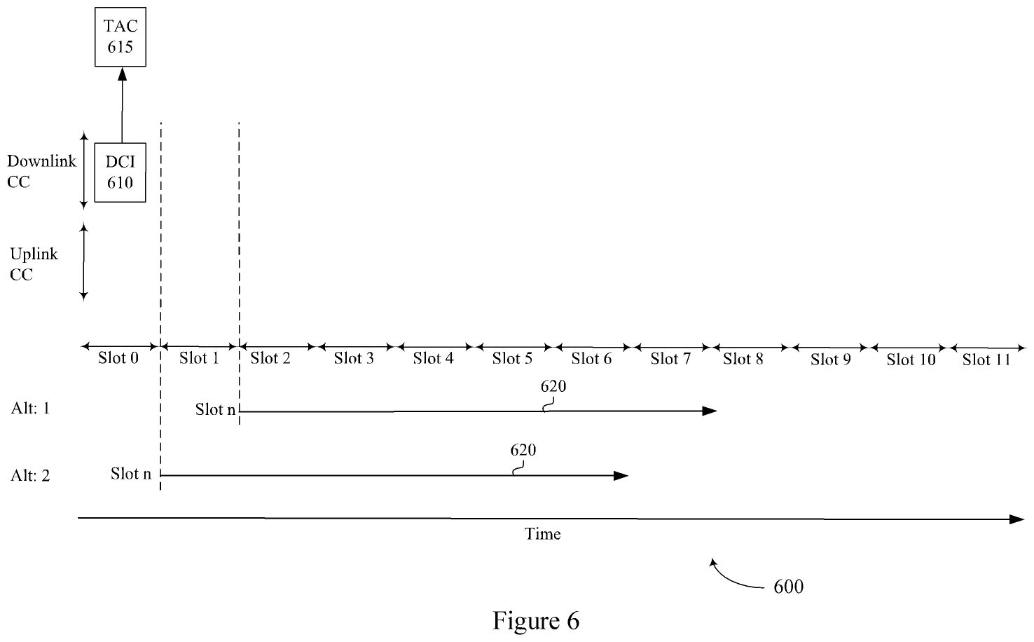

FIG. 6 illustrates an example of a timing diagram 600 that supports dynamic TA indication in DCI. In some implementations, the timing diagram 500 may implement aspects of wireless communications system 100 or the signaling diagram 300.

A UE 115 may operate according to a multi-DCI multi-TRP operation, as described herein. The UE 115 may operate with a downlink subcarrier spacing of 15 kHz and an uplink subcarrier spacing of 30 kHz with a K_{offset}=0. In this implementation, the reference subcarrier spacing for N and N₂ may be 15 kHz, which corresponds to N=10 and N₂=10, which corresponds to N_{T,1}=0.71 ms, N_{T,2}=0.71 ms. The reference subcarrier spacing for N_{TA,max} may be 30 kHz, which corresponds to N_{TA,max}=1 ms. The reference subcarrier spacing for slot n and Nₛₗₒₜ^{subframe,μ} may be 30 kHz, which corresponds to Nₛₗₒₜ^{subframe,μ}=2. Accordingly, k=┌Nₛₗₒₜ^{subframe,μ}·(N_{T,1}+N_{T,2}+N_{TA,max}+0.5)/T_{sf}┐=6 slots. Accordingly, the offset 620 after which a TA command is applicable may be selected, calculated, ascertained, or determined in accordance with k+2^{μ}·K_{offset}=6 slots.

The UE 115 receives a DCI message 610 that includes a TA command in slot 0. In implementations where the uplink slot n may be selected, calculated, ascertained, or determined based on the last slot among uplink slot(s) overlapping with the slot(s) of PDCCH in which the DCI message 610 was conveyed, slot 1 corresponds to slot n and therefore given the offset 620 equals 6 slots, the TA indicated in the TA command 615 is applicable in slot 8. In implementations where the uplink slot n may be selected, calculated, ascertained, or determined based on the last slot among uplink slot(s) overlapping with the symbol(s) of PDCCH in which the DCI message 610 was conveyed, slot 0 corresponds to slot n and therefore given the offset 620 equals 6 slots, the TA indicated in the TA command 615 is applicable in slot 7.

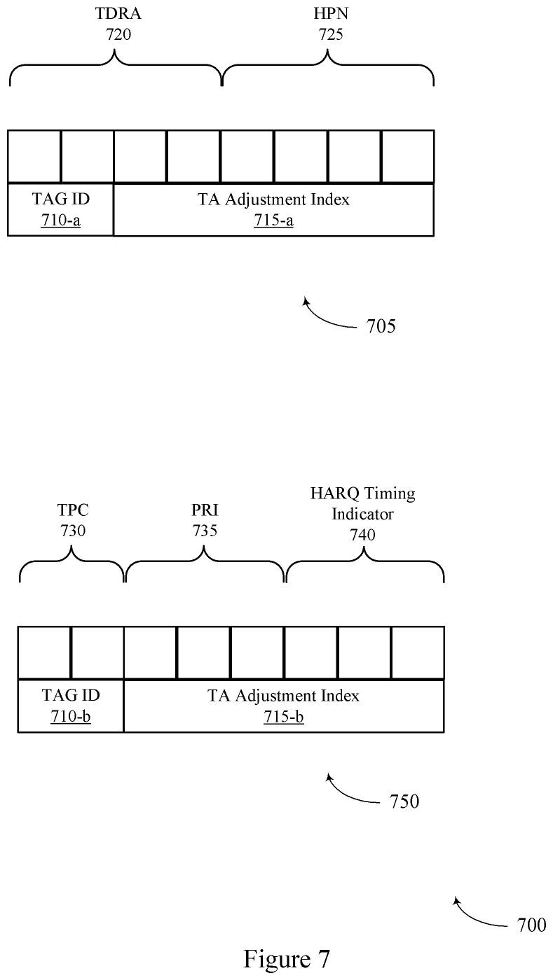

FIG. 7 illustrates an example of a resource diagram 700 that supports dynamic TA indication in DCI. In some implementations, the resource diagram 700 may implement aspects of wireless communications system 100 or the signaling diagram 300.

As described herein, to indicate a TA adjustment value for a given CORESETPoolIndex value, a TA adjustment index value for uplink associated with a CORESETPoolIndex value may be indicated by one or more bit fields in an uplink DCI message or a downlink DCI message. In some implementations, the given CORESETPoolIndex may be the same as the CORESETPoolIndex of the CORESET where the uplink DCI is received.

In some implementations, the given CORESETPoolIndex may be the same as the CORESETPoolIndex that is associated with the indicated TAG identifier (such as in implementations where two TAG identifiers are configured for a serving cell). The TA value associated with the given CORESETPoolIndex value may be selected, calculated, ascertained, or determined based on the current TA value N_{TA}_{_{old,}}_{TRPx}, and the TA adjustment value associated with the given CORESETPoolIndex value. For example, the new TA value (N_{TA}_{_{new,TRPx}})=N_{TA}_{_{old,}}_{TRPx}+(T_{A,TRPx}−31)·16·64/2^{μ}, T_{A,TRPx}=0,1,2,3, . . . , 63.

In some implementations, as shown in an uplink DCI example 705, the TAG identifier 710-a may be indicated in two bits of the TDRA field 720, and the TA adjustment index value 715-a (T_{A,TRPx}) may be indicated in remaining bits of the TDRA field 720 and in bits of the HPN field 725. In some implementations, as shown in a downlink DCI example 750, the TAG identifier 710-b may be indicated in two bits of the TPC field 730, and the TA adjustment index value 715-b (T_{A,TRPx}) may be indicated in bits of the PUCCH resource indicator (PRI) field 735 and the PDSCH-to-HARQ feedback timing indicator 740. In some implementations, the TAG identifier may not be included in the DCI message.

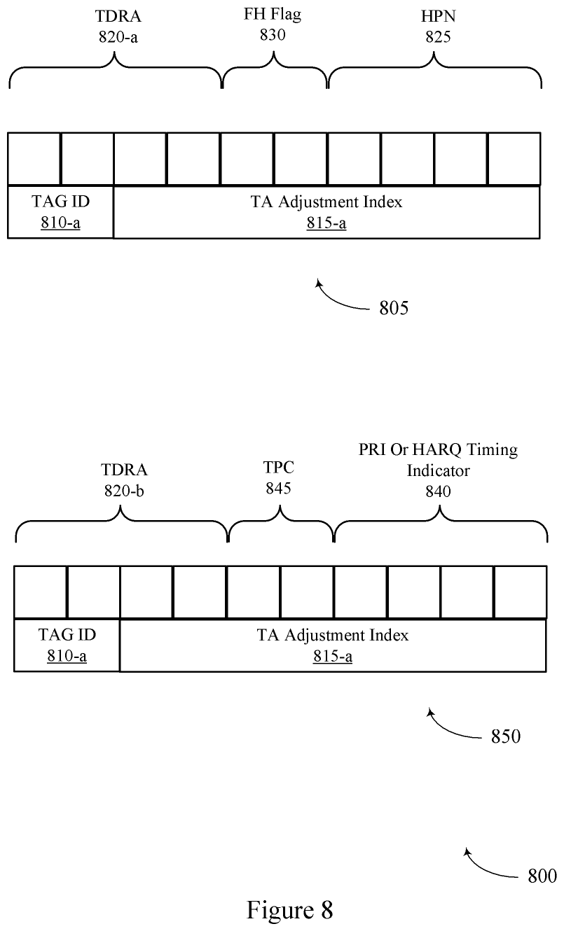

FIG. 8 illustrates an example of a resource diagram 800 that supports dynamic TA indication in DCI. In some implementations, the resource diagram 800 may implement aspects of wireless communications system 100 or the signaling diagram 300.

As described herein, to indicate a TA adjustment offset value for uplink transmissions associated with a second CORESETPoolIndex value with respect to the timing adjustment value of an uplink transmission associated with a reference CORESETPoolIndex value, a TA adjustment offset index value for an uplink transmission associated with the second CORESETPoolIndex may be indicated by the remaining fields in an uplink DCI or a downlink DCI. The reference CORESETPoolIndex may be predefined (such as the lowest CORESETPoolIndex value, 0) or RRC configured. The TA adjustment index value associated with the second CORESETPoolIndex value (T_{A,TRP2}) may be selected, calculated, or determined as T_{A,TRP2}=T_{A,TRP1}+(ΔT_{A}−63), where T_{A,TRP1} refers to the TA adjustment index value associated with the reference CORESETPoolIndex value and ΔT_{A} refers to the TA adjustment offset index value. The step size of ΔT_{A} may be predefined or configured, for example, if the step size of ΔT_{A} is 1, ΔT_{A}=0,1,2,3, . . . ,126. The TA value associated with the second CORESETPoolIndex value (N_{TA}_{_{new,TRP2}}) may be selected, calculated, or determined as N_{TA}_{_{new,TRP2}}=N_{TA}_{_{old,}}_{TRP2}+(T_{A,TRP2}−31)·16·64/2^{μ}.

In some implementations, as shown in an uplink DCI example 805, the TAG identifier 810-a may be indicated in two bits of the TDRA field 820-a, and the TA adjustment index value 815-a (T_{A,TRPx}) may be indicated in remaining bits of the TDRA field 820-a, in bits of the frequency hopping flag field 830, and in bits of the HPN field 825. In some implementations, as shown in a downlink DCI example 850, the TAG identifier 810-b may be indicated in two bits of the TDRA field 820-b, and the timing adjustment index value 815-a (T_{A,TRPx}) may be indicated in two bits of the TDRA field 820-b and bits of the TPC field 845, or the PRI or PDSCH-to-HARQ feedback timing indicator field 840. In some implementations, the TAG identifier may not be included in the DCI message.

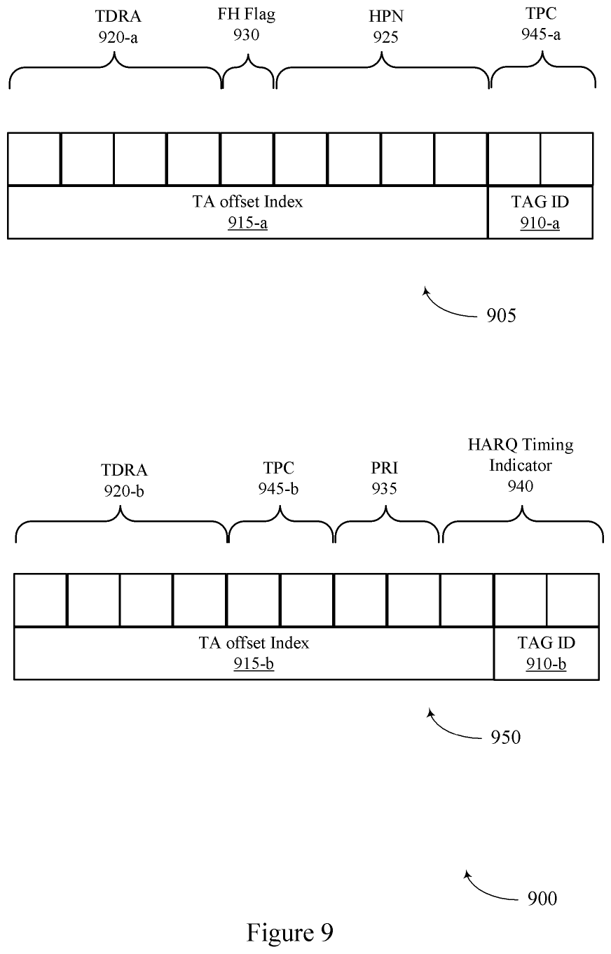

FIG. 9 illustrates an example of a resource diagram 900 that supports dynamic TA indication in DCI. In some implementations, the resource diagram 900 may implement aspects of wireless communications system 100 or the signaling diagram 300.

To indicate TA offset value for uplink transmissions associated with a second CORESETPoolIndex value with respect to a TA value of a reference CORESETPoolIndex value, a TA offset index value for uplink transmissions associated with the second CORESETPoolIndex value can be indicated by the remaining fields in an uplink DCI or a downlink DCI. The reference CORESETPoolIndex may be predefined (such as the lowest CORESETPoolIndex value, 0) or RRC configured.

For FR1, the TA value associated with the second CORESETPoolIndex value (N_{TA}_{_{new,TRP2}}) may be selected, calculated, or determined as N_{TA}_{_{new,TRP2}}=N_{TA}_{_{new,TRP1}}+(ΔT_{TA}−66·2^{μ})·16·64/2^{μ}, ΔT_{TA}=[0, . . . , 132·2^{μ}]. For FR2, N_{TA}_{_{new,TRP2}}=N_{TA}_{_{new,TRP1}}+(ΔT_{TA}−16·2^{μ})·16·64/2^{μ} ΔT_{TA}=[0, . . . , 32. 2^{μ}]. N_{TA}_{_{new,TRP1}} refers to the N_{TA} value associated with the reference CORESETPoolIndex value, and ΔT_{TA} refers to the TA offset index. The step size of size of ΔT_{TA} may be predefined or configured (such as RRC configured). For example, if μ=0 and the step size of ΔT_{TA} is 1, ΔT_{TA}=0,1, 2, 3, . . . ,132.

In some implementations, as shown in an uplink DCI example 905, the TA offset index 915-a may be indicated in the 4 bits of the TDRA field 920-a, the bits of the frequency hopping flag field 930, and the bits of the HPN field 925. The TAG identifier 910-a may be indicated in the bits of the TPC field 945-a. In some implementations, as shown in a downlink DCI example 950, the TA offset index 915-b may be indicated in the 4 bits of the TDRA field 920-b, the 2 bits of the TPC field 945-b, the two bits of the PRI field 935, and one bit of PDSCH-to-HARQ feedback timing indicator field 940. The TAG identifier 910-b may be indicated in two bits of the HARQ timing indicator field 940.

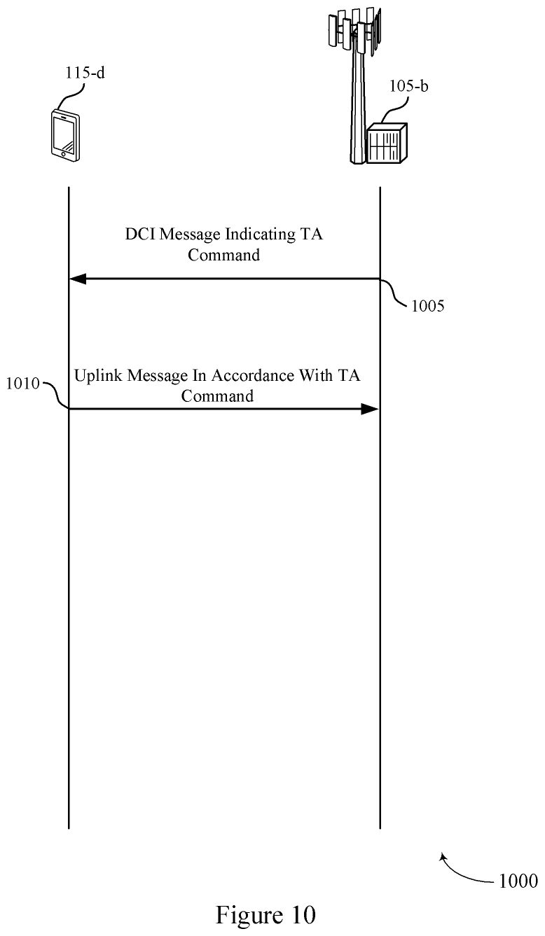

FIG. 10 illustrates an example of a process flow 1000 that supports dynamic TA indication in DCI. The process flow 1000 may include a UE 115-d, which may be an example of a UE 115 as described herein. The process flow 1000 may include a network entity 105-b, which may be an example of a network entity 105 as described herein. In the following description of the process flow 1000, the operations between the network entity 105-b and the UE 115-d may be transmitted in a different order than the example order shown, or the operations performed by the network entity 105-b and the UE 115-d may be performed in different orders or at different times. Some operations also may be omitted from the process flow 1000, and other operations may be added to the process flow 1000.

At 1005, the network entity 105-b may transmit, to the UE 115-d, a DCI message including one or more fields associated with scheduling information for a communication between the UE 115-d and the network entity 105-b. The DCI message may be received in a DCI format that includes a CRC scrambled by a CS-RNTI, and the one or more fields may be populated with values that indicate that the DCI message includes a TA command.

At 1010, the UE 115-d may transmit, to the network entity, an uplink message associated with the TA command indicated in the DCI message received at 1005.

In some implementations, the DCI message is an uplink DCI message, and the uplink DCI message indicates the TA command instead of scheduling an uplink shared channel message, or activating or releasing a CG configuration.

In some implementations, the DCI message is a downlink DCI message, and the downlink DCI message indicates the TA command instead of scheduling a downlink shared channel message, or activating or releasing an SPS configuration.

In some implementations, transmitting the uplink message associated with the TA command includes applying the TA command to the uplink message which is scheduled on one of one or more CCs that are associated with a TAG identifier that is included in the TA command. In some implementations, transmitting the uplink message associated with the TA command further includes applying the TA command to the uplink message in one of the one or more CCs, the one of the one or more CCs being associated with the TAG identifier that is included in the TA command. In some implementations, each of the one or more CCs is associated with multiple different TA commands with corresponding different TAG identifiers, and the UE 115-d further applies the TA command to the uplink message in one of the one or more CCs, the uplink message in one of the one or more CCs being associated with a CORESET pool index that is also associated with the TAG identifier that is included in the TA command. In some implementations, each of the one or more CCs is associated with multiple different TA commands all associated with the TAG identifier, and the UE 115-d further applies the TA command to the uplink message in the one or more CCs, the uplink message in the one or more CCs being associated with CORESET pool index in which the DCI message was received.

In some implementations, transmitting the uplink message associated with the TA command includes applying the TA command to the uplink message, which is scheduled in one of one or more CCs, the one of the one or more CCs being selected in accordance with whether a CIF is present in the DCI message. In some implementations, where the CIF is present in the DCI message, the one of the one or more CCs may be associated with a TAG identifier associated with a CC indicated by the CIF. In some implementations, where the CIF is absent from the DCI message, the one of the one or more CCs may be associated with a TAG identifier associated with a default CC. In some implementations, the default CC may be an uplink CC that is associated with a downlink CC in which the DCI message is received. In some implementations, the uplink message in one of the one or more CCs is associated with a CORESET pool index of a CORESET in which the DCI message was received.

In some implementations, the DCI message may be received in one or more symbols of a DCI reception slot, and the TA command may be applicable a number of slots after a designated slot associated with the DCI reception slot, the number of slots being associated with SPS PDSCH release processing capability of the UE 115-d. In some implementations, the designated slot may be a last slot of a plurality of uplink slots that overlap with the DCI reception slot. In some implementations, the designated slot may be a last slot of a set of multiple uplink slots that overlap with the one or more symbols of the DCI reception slot.

In some implementations, where the TA command is a TA adjustment index value associated with a CORESET pool index, transmitting the uplink message associated with the TA command indicated in the DCI message further includes transmitting the uplink message using a TA that is associated with a previous TA value associated with the CORESET pool index and the TA adjustment index value. In some implementations, the CORESET pool index is a same CORESET pool index as that in which the DCI message was received. In some implementations, the CORESET pool index is a same CORESET pool index as that which is associated with a TAG identifier included in the DCI message.

In some implementations, where the TA command is a TA adjustment offset value associated with a first CORESET pool index and represents a TA offset with respect to a TA adjustment value associated with a reference CORESET pool index, transmitting the uplink message associated with the TA command indicated in the DCI message further includes transmitting the uplink message using a TA that is associated with a previous TA value associated with the first CORESET pool index, the TA adjustment value associated with the reference CORESET pool index, and the TA adjustment offset value associated with the first CORESET pool index. In some implementations, the UE 115-d may receive, from the network entity 105-b, an indication of the reference CORESET pool index.

In some implementations, where the TA command is a TA offset value associated with a first CORESET pool index and represents a TA offset with respect to a TA value associated with a reference CORESET pool index, transmitting the uplink message associated with the TA command indicated in the DCI message further includes transmitting the uplink message using a TA that is associated with a current TA value associated with the reference CORESET pool index and the TA offset value associated with the first CORESET pool index. In some implementations, the UE 115-d may receive, from the network entity 105-b, an indication of the reference CORESET pool index.

In some implementations, the one or more fields that are populated with the values that indicate that the DCI message includes the TA command include at least one of an RV field, an MCS field, an NDI field, an FDRA field, or an HPN field.

In some implementations, the TA command is indicated within the DCI message in at least one of a TDRA field, an HPN field, a frequency hopping flag field, a TPC field, a PUCCH resource indicator field, or a PDSCH-to-HARQ feedback timing indicator field.

In some implementations, the TA command indicates a timing adjustment with respect to a previous TA. In some implementations, the TA command indicates an absolute TA. In some implementations, the one or more fields of the DCI message populated with values that indicate that the DCI message includes the TA command are not populated with values that indicate the scheduling information for the communication between the UE and the network entity.

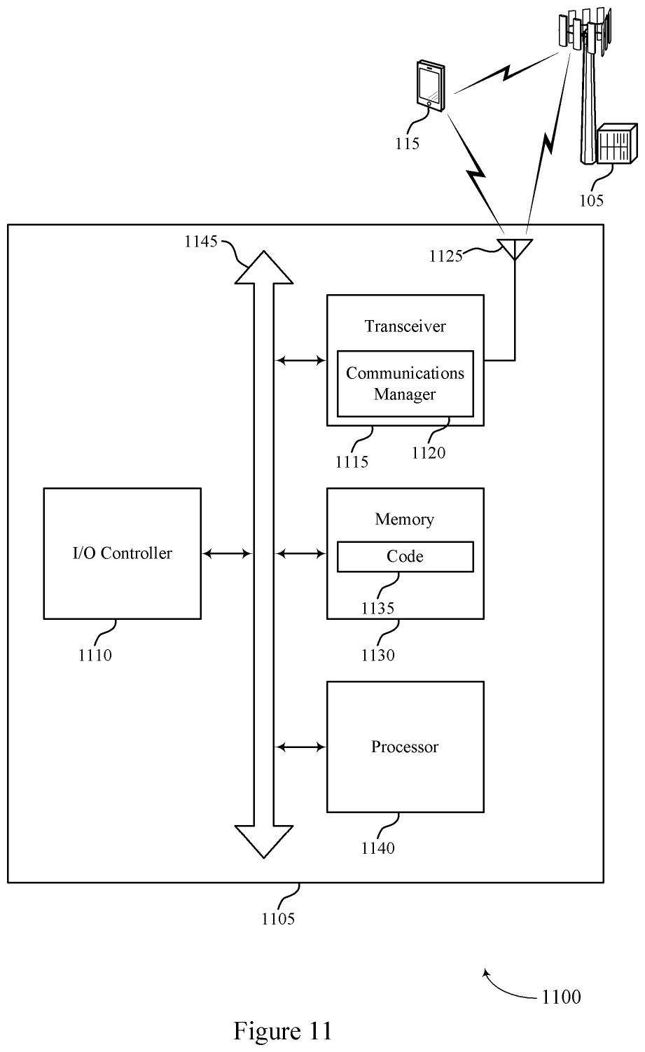

FIG. 11 shows a diagram of a system 1100 including a device 1105 that supports dynamic TA indication in DCI. The device 1105 may communicate (such as wirelessly) with one or more network entities (such as one or more components of one or more BSs), one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (such as operatively, communicatively, functionally, electronically, electrically) via one or more buses (such as a bus 1145).

The I/O controller 1110 may manage input and output signals for the device 1105. The I/O controller 1110 also may manage peripherals not integrated into the device 1105. In some implementations, the I/O controller 1110 may represent a physical connection or port to an external peripheral. In some implementations, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some implementations, the I/O controller 1110 may be implemented as part of a processor or processing system, such as the processor 1140. In some implementations, a user may interact with the device 1105 via the I/O controller 1110 or via hardware components controlled by the I/O controller 1110.

In some implementations, the device 1105 may include a single antenna 1125. However, in some other implementations, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 also may include a modem to modulate the packets, to provide the modulated packets to one or more antennas 1125 for transmission, and to demodulate packets received from the one or more antennas 1125. In some implementations, the transceiver 1115 may include one or more interfaces, such as one or more interfaces coupled with the one or more antennas 1125 that are configured to support various receiving or obtaining operations, or one or more interfaces coupled with the one or more antennas 1125 that are configured to support various transmitting or outputting operations, or a combination thereof. In some implementations, the transceiver 1115 may include or be configured for coupling with one or more processors or memory components that are operable to perform or support operations associated with received or obtained information or signals, or to generate information or other signals for transmission or other outputting, or any combination thereof. In some implementations, the transceiver 1115, or the transceiver 1115 and the one or more antennas 1125, or the transceiver 1115 and the one or more antennas 1125 and one or more processors or memory components (such as the processor 1140, or the memory 1130, or both), may be included in a chip or chip assembly that is installed in the device 1105.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some implementations, the code 1135 may not be directly executable by the processor 1140 but may cause a computer (such as when compiled and executed) to perform functions described herein. In some implementations, the memory 1130 may contain, among other things, a basic I/O system (BIOS) which may control basic hardware or software operation such as the interaction with peripheral components or devices.

The processor 1140 may be any one or more suitable processors capable of executing scripts or instructions of one or more software programs stored in the device 1105 (such as within the memory 1130). In some implementations, the processor 1140 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1140, or the transceiver 1115, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1105 may transmit information output from the chip or modem. In some implementations, the second interface may refer to an interface between the processing system of the chip or modem and a receiver, such that the device 1105 may obtain information or signal inputs, and the information may be passed to the processing system. A person having ordinary skill in the art will readily recognize that the first interface also may obtain information or signal inputs, and the second interface also may output information or signal outputs.

The communications manager 1120 may support wireless communications at a UE in accordance with examples as disclosed herein. For example, the communications manager 1120 may be configured as or otherwise support a means for receiving a DCI message including one or more fields associated with scheduling information for a communication between the UE and a network entity, where the DCI message is received in a DCI format that includes an CRC scrambled by a CS-RNTI, the one or more fields being populated with values that indicate that the DCI message includes a TA command. The communications manager 1120 may be configured as or otherwise support a means for transmitting, to the network entity, an uplink message associated with the TA command indicated in the DCI message.

In some implementations, the communications manager 1120 may be configured to perform various operations (such as receiving, monitoring, transmitting) using or otherwise in cooperation with the transceiver 1115, the one or more antennas 1125, or any combination thereof. Although the communications manager 1120 is illustrated as a separate component, in some implementations, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of dynamic TA indication in DCI as described herein, or the processor 1140 and the memory 1130 may be otherwise configured to perform or support such operations.

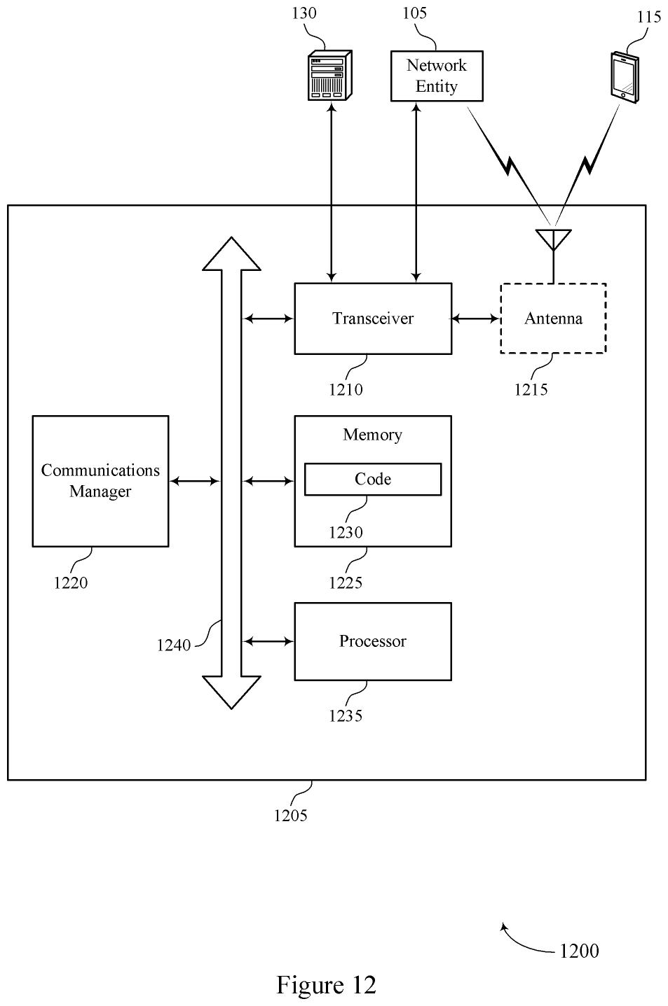

FIG. 12 shows a diagram of a system 1200 including a device 1205 that supports dynamic TA indication in DCI. The device 1205 may communicate with one or more network entities (such as one or more components of one or more BSs 140), one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (such as operatively, communicatively, functionally, electronically, electrically) via one or more buses (such as a bus 1240).

The transceiver 1210 may support bi-directional communications via wired links, wireless links, or both as described herein. In some implementations, the transceiver 1210 may include a wired transceiver and may communicate bi-directionally with another wired transceiver. Additionally, or alternatively, in some implementations, the transceiver 1210 may include a wireless transceiver and may communicate bi-directionally with another wireless transceiver. In some implementations, the device 1205 may include one or more antennas 1215, which may be capable of transmitting or receiving wireless transmissions (such as concurrently). The transceiver 1210 also may include a modem to modulate signals, to provide the modulated signals for transmission (such as by one or more antennas 1215, by a wired transmitter), to receive modulated signals (such as from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations associated with received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (such as the processor 1235, or the memory 1225, or both), may be included in a chip or chip assembly that is installed in the device 1205. In some implementations, the transceiver may be operable to support communications via one or more communications links (such as a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some implementations, the code 1230 may not be directly executable by the processor 1235 but may cause a computer (such as when compiled and executed) to perform functions described herein. In some implementations, the memory 1225 may contain, among other things, a BIOS which may control basic hardware or software operation such as the interaction with peripheral components or devices.

The processor 1235 may include an intelligent hardware device (such as a general-purpose processor, a DSP, an ASIC, a CPU, an FPGA, a microcontroller, a programmable logic device, discrete gate or transistor logic, a discrete hardware component, or any combination thereof). In some implementations, the processor 1235 may be configured to operate a memory array using a memory controller. In some other implementations, a memory controller may be integrated into the processor 1235. The processor 1235 may be configured to execute computer-readable instructions stored in a memory (such as the memory 1225) to cause the device 1205 to perform various functions (such as functions or tasks supporting dynamic TA indication in DCI). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (such as one or more physical nodes and supporting software such as operating systems, virtual machines, or container instances) that may host the functions (such as by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1205 may transmit information output from the chip or modem. In some implementations, the second interface may refer to an interface between the processing system of the chip or modem and a receiver, such that the device 1205 may obtain information or signal inputs, and the information may be passed to the processing system. A person having ordinary skill in the art will readily recognize that the first interface also may obtain information or signal inputs, and the second interface also may output information or signal outputs.

In some implementations, a bus 1240 may support communications of (such as within) a protocol layer of a protocol stack. In some implementations, a bus 1240 may support communications associated with a logical channel of a protocol stack (such as between protocol layers of a protocol stack), which may include communications performed within a component of the device 1205, or between different components of the device 1205 that may be co-located or located in different locations (such as where the device 1205 may refer to a system in which one or more of the communications manager 1220, the transceiver 1210, the memory 1225, the code 1230, and the processor 1235 may be located in one of the different components or divided between different components).

In some implementations, the communications manager 1220 may manage aspects of communications with a core network 130 (such as via one or more wired or wireless backhaul links). For example, the communications manager 1220 may manage the transfer of data communications for client devices, such as one or more UEs 115. In some implementations, the communications manager 1220 may manage communications with other network entities 105, and may include a controller or scheduler for controlling communications with UEs 115 in cooperation with other network entities 105. In some implementations, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for transmitting, to a UE, a DCI message including one or more fields associated with scheduling information for a communication between the network entity and the UE, where the DCI message is transmitted in a DCI format that includes an CRC scrambled by a CS-RNTI, the one or more fields being populated with values that indicate that the DCI message includes a TA command. The communications manager 1220 may be configured as or otherwise support a means for receiving, from the UE, an uplink message associated with the TA command indicated in the DCI message.

In some implementations, the communications manager 1220 may be configured to perform various operations (such as receiving, obtaining, monitoring, outputting, transmitting) using or otherwise in cooperation with the transceiver 1210, the one or more antennas 1215 (such as where applicable), or any combination thereof. Although the communications manager 1220 is illustrated as a separate component, in some implementations, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of dynamic TA indication in DCI as described herein, or the processor 1235 and the memory 1225 may be otherwise configured to perform or support such operations.

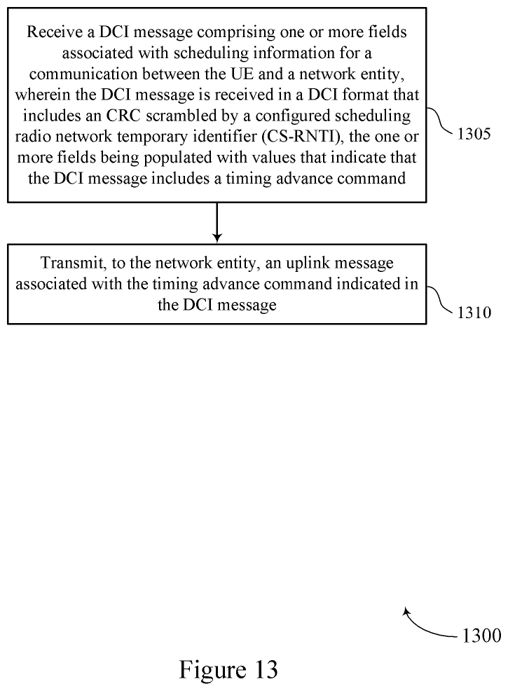

FIG. 13 shows a flowchart illustrating a method 1300 that supports dynamic TA indication in DCI. The operations of the method 1300 may be implemented by a UE or its components as described herein. For example, the operations of the method 1300 may be performed by a UE 115 as described with reference to FIGS. 1 through 11. In some implementations, a UE may execute a set of instructions to control the functional elements of the UE to perform the described functions. Additionally, or alternatively, the UE may perform aspects of the described functions using special-purpose hardware.

At 1305, the method may include receiving a DCI message including one or more fields associated with scheduling information for a communication between the UE and a network entity, where the DCI message is received in a DCI format that includes an CRC scrambled by a CS-RNTI, the one or more fields being populated with values that indicate that the DCI message includes a TA command. The operations of 1305 may be performed in accordance with examples as disclosed herein.

At 1310, the method may include transmitting, to the network entity, an uplink message associated with the TA command indicated in the DCI message. The operations of 1310 may be performed in accordance with examples as disclosed herein.

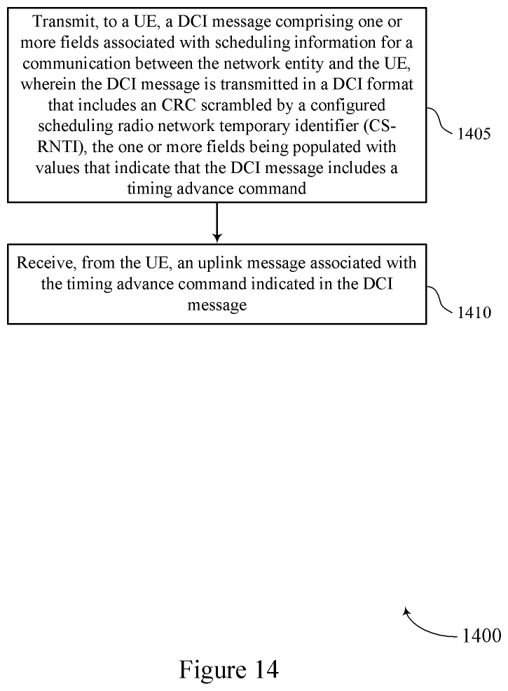

FIG. 14 shows a flowchart illustrating a method 1400 that supports dynamic TA indication in DCI. The operations of the method 1400 may be implemented by a network entity or its components as described herein. For example, the operations of the method 1400 may be performed by a network entity as described with reference to FIGS. 1 through 10 and 12. In some implementations, a network entity may execute a set of instructions to control the functional elements of the network entity to perform the described functions. Additionally, or alternatively, the network entity may perform aspects of the described functions using special-purpose hardware.

At 1405, the method may include transmitting, to a UE, a DCI message including one or more fields associated with scheduling information for a communication between the network entity and the UE, where the DCI message is transmitted in a DCI format that includes an CRC scrambled by a CS-RNTI, the one or more fields being populated with values that indicate that the DCI message includes a TA command. The operations of 1405 may be performed in accordance with examples as disclosed herein.

At 1410, the method may include receiving, from the UE, an uplink message associated with the TA command indicated in the DCI message. The operations of 1410 may be performed in accordance with examples as disclosed herein.

The following provides an overview of some aspects of the present disclosure:

Aspect 1: A method for wireless communications at a UE, including: receiving a DCI message including one or more fields associated with scheduling information for a communication between the UE and a network entity, where the DCI message is received in a DCI format that includes an CRC scrambled by a CS-RNTI, the one or more fields being populated with values that indicate that the DCI message includes a timing advance command; and transmitting, to the network entity, an uplink message associated with the timing advance command indicated in the DCI message.

Aspect 2: The method of aspect 1, where receiving the DCI message includes: receiving an uplink DCI message, where the uplink DCI message indicates the timing advance command instead of scheduling an uplink shared channel message, or activating or releasing a CG configuration.

Aspect 3: The method of aspect 1, where receiving the DCI message includes: receiving a downlink DCI message, where the downlink DCI message indicates the timing advance command instead of scheduling a downlink shared channel message, or activating or releasing an SPS configuration.

Aspect 4: The method of any of aspects 1 through 3, where transmitting the uplink message associated with the timing advance command further includes: applying the timing advance command to the uplink message which is scheduled on one of one or more CCs that are associated with a TAG identifier (TAG-ID) that is included in the timing advance command.

Aspect 5: The method of aspect 4, where each of the one or more CCs is associated with a single timing advance command, the method further including: applying the timing advance command to the uplink message in one of the one or more CCs, the one of the one or more CCs being associated with the TAG-ID that is included in the timing advance command.

Aspect 6: The method of aspect 4, where each of the one or more CCs is associated with multiple different timing advance commands with corresponding different TAG-IDs, the method further including: applying the timing advance command to the uplink message in one of the one or more CCs, the uplink message in one of the one or more CCs being associated with a CORESET pool index that is also associated with the TAG-ID that is included in the timing advance command.

Aspect 7: The method of aspect 4, where each of the one or more CCs is associated with multiple different timing advance commands all associated with the TAG-ID, the method further including: applying the timing advance command to the uplink message in the one or more CCs, the uplink message in the one or more CCs being associated with a CORESET pool index in which the DCI message was received.

Aspect 8: The method of any of aspects 1 through 3, where transmitting the uplink message associated with the timing advance command further includes: applying the timing advance command to the uplink message which is scheduled in one of one or more CCs, the one of the one or more component carriers being selected based on whether a CIF is present in the DCI message.

Aspect 9: The method of aspect 8, where the CIF is present in the DCI message, the one of the one or more CCs being associated with a TAG-ID associated with a CC indicated by the CIF.

Aspect 10: The method of aspect 8, where the CIF is absent from the DCI message, the one of the one or more CCs being associated with a TAG-ID associated with a default CC.

Aspect 11: The method of aspect 10, where the default CC is an uplink CC that is associated with a downlink CC in which the DCI message is received.

Aspect 12: The method of aspect 8, where the uplink message in one of the one or more CCs is associated with a CORESET pool index of a CORESET in which the DCI message was received.

Aspect 13: The method of any of aspects 1 through 12, where receiving the DCI message includes: receiving the DCI message in one or more symbols of a DCI reception slot, where the timing advance command is applicable a determined number of slots after a designated slot associated with the DCI reception slot, the determined number of slots being based on an SPS PDSCH release processing capability of the UE.

Aspect 14: The method of aspect 13, where the designated slot is a last slot of a set of multiple uplink slots that overlap with the DCI reception slot.

Aspect 15: The method of aspect 13, where the designated slot is a last slot of a set of multiple uplink slots that overlap with the one or more symbols of the DCI reception slot.

Aspect 16: The method of any of aspects 1 through 15, where the timing advance command is a timing advance adjustment index value associated with a CORESET pool index, where transmitting the uplink message associated with the timing advance command indicated in the DCI message further includes: transmitting the uplink message using a timing advance that is based on a previous timing advance value associated with the CORESET pool index and the timing advance adjustment index value.

Aspect 17: The method of aspect 16, where the CORESET pool index is a same as that in which the DCI message was received.

Aspect 18: The method of aspect 16, where the CORESET pool index is a same as that which is associated with a TAG-ID included in the DCI message.

Aspect 19: The method of any of aspects 1 through 15, where the timing advance command is a timing advance adjustment offset value associated with a first CORESET pool index and represents a timing advance offset with respect to a timing advance adjustment value associated with a reference CORESET pool index, where transmitting the uplink message associated with the timing advance command indicated in the DCI message further includes: transmitting the uplink message using a timing advance that is based on a previous timing advance value associated with the first CORESET pool index, the timing advance adjustment value associated with the reference CORESET pool index, and the timing advance adjustment offset value associated with the first CORESET pool index.

Aspect 20: The method of aspect 19, further including: receiving an indication of the reference CORESET pool index.

Aspect 21: The method of any of aspects 1 through 15, where the timing advance command is a timing advance offset value associated with a first CORESET pool index and represents a timing advance offset with respect to a timing advance value associated with a reference CORESET pool index, where transmitting the uplink message associated with the timing advance command indicated in the DCI message further includes: transmitting the uplink message using a timing advance that is based on a current timing advance value associated with the reference CORESET pool index and the timing advance offset value associated with the first CORESET pool index.

Aspect 22: The method of aspect 21, further including: receiving an indication of the reference CORESET pool index.

Aspect 23: The method of any of aspects 1 through 22, where the one or more fields that are populated with the values that indicate that the DCI message includes the timing advance command include at least one of an RV field, an MCS field, an NDI field, an FDRA field, or an HPN field.

Aspect 24: The method of any of aspects 1 through 23, where the timing advance command is indicated within the DCI message in at least one of a TDRA field, an HPN field, a frequency hopping flag field, a TPC field, a PUCCH resource indicator field, or an PDSCH-to-HARQ feedback timing indicator field.

Aspect 25: The method of any of aspects 1 through 24, where the timing advance command indicates a timing adjustment with respect to a previous timing advance.

Aspect 26: The method of any of aspects 1 through 24, where the timing advance command indicates an absolute timing advance.

Aspect 27: The method of any of aspects 1 through 26, where the one or more fields of the DCI message populated with values that indicate that the DCI message includes the timing advance command are not populated with values that indicate the scheduling information for the communication between the UE and the network entity.

Aspect 28: A method for wireless communications at a network entity, including: transmitting, to a UE, a DCI message including one or more fields associated with scheduling information for a communication between the network entity and the UE, where the DCI message is transmitted in a DCI format that includes an CRC scrambled by a CS-RNTI, the one or more fields being populated with values that indicate that the DCI message includes a timing advance command; and receiving, from the UE, an uplink message associated with the timing advance command indicated in the DCI message.

Aspect 29: The method of aspect 28, where transmitting the DCI message includes: transmitting an uplink DCI message, where the uplink DCI message indicates the timing advance command instead of scheduling an uplink shared channel message, or activating or releasing a CG configuration.

Aspect 30: The method of aspect 28, where transmitting the DCI message includes: transmitting a downlink DCI message, where the downlink DCI message indicates the timing advance command instead of scheduling a downlink shared channel message, or activating or releasing an SPS configuration.

Aspect 31: The method of any of aspects 28 through 30, where receiving the uplink message further includes: receiving the uplink message via one or more CCs that are associated with a TAG-ID that is included in the timing advance command.

Aspect 32: The method of any of aspects 28 through 30, where receiving the uplink message further includes: receiving the uplink message via one of one or more CCs, the one of the one or more component carriers being selected based on whether a CIF is present in the DCI message.

Aspect 33: The method of aspect 32, where the CIF is present in the DCI message, the one or more CCs being associated with a TAG-ID associated with a CC indicated by the CIF.

Aspect 34: The method of aspect 32, where the CIF is absent from the DCI message, the one or more CCs being associated with a TAG-ID associated with a default CC.

Aspect 35: The method of aspect 34, where the default CC is an uplink CC that is associated with a downlink CC in which the DCI message is transmitted.

Aspect 36: The method of aspect 32, where uplink message in the one or more CCs is associated with a CORESET pool index of a CORESET in which the DCI message was transmitted.

Aspect 37: The method of any of aspects 28 through 36, where the timing advance command is a timing advance adjustment index value associated with a CORESET pool index.

Aspect 38: The method of any of aspects 28 through 37, where a CORESET pool index associated with the timing advance command is a same as that in which the DCI message was transmitted.

Aspect 39: The method of any of aspects 28 through 37, where a CORESET pool index associated with the timing advance command is a same as that which is associated with a TAG-ID included in the DCI message.

Aspect 40: The method of any of aspects 28 through 37, where the timing advance command is a timing advance adjustment offset value associated with a first CORESET pool index and represents a timing advance offset with respect to a timing advance adjustment value associated with a reference CORESET pool index.

Aspect 41: The method of aspect 40, further including: transmitting an indication of the reference CORESET pool index.

Aspect 42: The method of any of aspects 28 through 37, where the timing advance command is a timing advance offset value associated with a first CORESET pool index and represents a timing advance offset with respect to a timing advance value associated with a reference CORESET pool index.

Aspect 43: The method of aspect 42, further including: transmitting an indication of the reference CORESET pool index.

Aspect 44: The method of any of aspects 28 through 43, where the one or more fields that are populated with the values that indicate that the DCI message includes the timing advance command include at least one of an RV) field, an MCS field, an NDI field, an FDRA field, or an HPN field.

Aspect 45: The method of any of aspects 28 through 44, where the timing advance command is indicated within the DCI message in at least one of a TDRA field, an HPN field, a frequency hopping flag field, a TPC field, a PUCCH resource indicator field, or an PDSCH-to-HARQ feedback timing indicator field.

Aspect 46: The method of any of aspects 28 through 45, where the timing advance command indicates a timing adjustment with respect to a previous timing advance.

Aspect 47: The method of any of aspects 28 through 45, where the timing advance command indicates an absolute timing advance.

Aspect 48: The method of any of aspects 28 through 47, where the one or more fields of the DCI message populated with values that indicate that the DCI message includes the timing advance command are not populated with values that indicate the scheduling information for the communication between the UE and the network entity.

Aspect 49: An apparatus for wireless communications at a UE, including: one or more interfaces configured to: obtain a DCI message including one or more fields associated with scheduling information for a communication between the UE and a network entity, where the DCI message is received in a DCI format that includes an CRC scrambled by a CS-RNTI, the one or more fields being populated with values that indicate that the DCI message includes a timing advance command; and output, to the network entity, an uplink message associated with the timing advance command indicated in the DCI message.

Aspect 50: The apparatus of aspect 49, where to obtain the DCI message, the one or more interfaces are further configured to: obtain an uplink DCI message, where the uplink DCI message indicates the timing advance command instead of scheduling an uplink shared channel message, or activating or releasing a CG configuration.

Aspect 51: The apparatus of aspect 49, where to obtain the DCI message, the one or more interfaces are further configured to: obtain a downlink DCI message, where the downlink DCI message indicates the timing advance command instead of scheduling a downlink shared channel message, or activating or releasing an SPS configuration.

Aspect 52: The apparatus of any of aspects 49 through 51, where to output the uplink message associated with the timing advance command, the one or more interfaces are further configured to: apply the timing advance command to the uplink message which is scheduled on one of one or more CCs that are associated with a TAG-ID that is included in the timing advance command.

Aspect 53: The apparatus of aspect 52, where each of the one or more CCs is associated with a single timing advance command, and where the one or more interfaces are further configured to: apply the timing advance command to the uplink message in one of the one or more CCs, the one of the one or more CCs being associated with the TAG-ID that is included in the timing advance command.

Aspect 54: The apparatus of aspect 52, where each of the one or more CCs is associated with multiple different timing advance commands with corresponding different TAG-IDs, and the one or more interfaces are further configured to: apply the timing advance command to the uplink message in one of the one or more CCs, the uplink message in one of the one or more CCs being associated with a CORESET pool index that is also associated with the TAG-ID that is included in the timing advance command.

Aspect 55: The apparatus of aspect 52, where each of the one or more CCs is associated with multiple different timing advance commands all associated with the TAG-ID, and the one or more interfaces are further configured to: apply the timing advance command to the uplink message in the one or more CCs, the uplink message in the one or more CCs being associated with a CORESET pool index in which the DCI message was obtained.

Aspect 56: The apparatus of any of aspects 49 through 51, where to output the uplink message associated with the timing advance command, the one or more interfaces are further configured to: apply the timing advance command to the uplink message which is scheduled in one of one or more CCs, the one of the one or more component carriers being selected based on whether a CIF is present in the DCI message.

Aspect 57: The apparatus of aspect 56, where the CIF is present in the DCI message, the one of the one or more CCs being associated with a TAG-ID associated with a CC indicated by the CIF.

Aspect 58: The apparatus of aspect 56, where the CIF is absent from the DCI message, the one of the one or more CCs being associated with a TAG-ID associated with a default CC.

Aspect 59: The apparatus of aspect 58, where the default CC is an uplink CC that is associated with a downlink CC in which the DCI message is obtained.

Aspect 60: The apparatus of any of aspects 56 through 59, where the uplink message in one of the one or more CCs is associated with a CORESET pool index of a CORESET in which the DCI message was obtained.

Aspect 61: The apparatus of any of aspects 49 through 60, where to obtain the DCI message, the one or more interfaces are further configured to: obtain the DCI message in one or more symbols of a DCI reception slot, where the timing advance command is applicable a determined number of slots after a designated slot associated with the DCI reception slot, the determined number of slots being based on an SPS PDSCH release processing capability of the UE.

Aspect 62: The apparatus of aspect 61, where the designated slot is a last slot of a set of multiple uplink slots that overlap with the DCI reception slot.

Aspect 63: The apparatus of aspect 61, where the designated slot is a last slot of a set of multiple uplink slots that overlap with the one or more symbols of the DCI reception slot.

Aspect 64: The apparatus of any of aspects 49 through 63, where the timing advance command is a timing advance adjustment index value associated with a CORESET pool index, where to output the uplink message associated with the timing advance command indicated in the DCI message the one or more interfaces are further configured to: output the uplink message using a timing advance that is based on a previous timing advance value associated with the CORESET pool index and the timing advance adjustment index value.

Aspect 65: The apparatus of aspect 64, where the CORESET pool index is a same as that in which the DCI message was obtained.

Aspect 66: The apparatus of aspect 64, where the CORESET pool index is a same as that which is associated with a TAG-ID included in the DCI message.

Aspect 67: The apparatus of any of aspects 49 through 63, where the timing advance command is a timing advance adjustment offset value associated with a first CORESET pool index and represents a timing advance offset with respect to a timing advance adjustment value associated with a reference CORESET pool index, where to output the uplink message associated with the timing advance command indicated in the DCI message, the one or more interfaces are further configured to: output the uplink message using a timing advance that is based on a previous timing advance value associated with the first CORESET pool index, the timing advance adjustment value associated with the reference CORESET pool index, and the timing advance adjustment offset value associated with the first CORESET pool index.

Aspect 68: The apparatus of aspect 67, where the one or more interfaces are further configured to: obtain an indication of the reference CORESET pool index.

Aspect 69: The apparatus of any of aspects 49 through 63, where the timing advance command is a timing advance offset value associated with a first CORESET pool index and represents a timing advance offset with respect to a timing advance value associated with a reference CORESET pool index, where to output the uplink message associated with the timing advance command indicated in the DCI message, the one or more interfaces are further configured to: output the uplink message using a timing advance that is based on a current timing advance value associated with the reference CORESET pool index and the timing advance offset value associated with the first CORESET pool index.

Aspect 70: The apparatus of aspect 69, where the one or more interfaces are further configured to: obtain an indication of the reference CORESET pool index.

Aspect 71: The apparatus of any of aspects 49 through 70, where the one or more fields that are populated with the values that indicate that the DCI message includes the timing advance command include at least one of an RV field, an MCS field, an NDI field, an FDRA field, or an HPN field.

Aspect 72: The apparatus of any of aspects 49 through 71, where the timing advance command is indicated within the DCI message in at least one of a TDRA field, an HPN field, a frequency hopping flag field, a TPC field, a PUCCH resource indicator field, or an PDSCH-to-HARQ feedback timing indicator field.

Aspect 73: The apparatus of any of aspects 49 through 72, where the timing advance command indicates a timing adjustment with respect to a previous timing advance.

Aspect 74: The apparatus of any of aspects 49 through 72, where the timing advance command indicates an absolute timing advance.

Aspect 75: The apparatus of any of aspects 49 through 74, where the one or more fields of the DCI message populated with values that indicate that the DCI message includes the timing advance command are not populated with values that indicate the scheduling information for the communication between the UE and the network entity.

Aspect 76: An apparatus for wireless communications at a network entity, including: one or more interfaces configured to: output, to a UE, a DCI message including one or more fields associated with scheduling information for a communication between the network entity and the UE, where the DCI message is output in a DCI format that includes an CRC scrambled by a CS-RNTI, the one or more fields being populated with values that indicate that the DCI message includes a timing advance command; and obtain, from the UE, an uplink message associated with the timing advance command indicated in the DCI message.

Aspect 77: The apparatus of aspect 76, where to output the DCI message, the one or more interfaces are further configured to: output an uplink DCI message, where the uplink DCI message indicates the timing advance command instead of scheduling an uplink shared channel message, or activating or releasing a CG configuration.

Aspect 78: The apparatus of aspect 76, where to output the DCI message, the one or more interfaces are further configured to: output a downlink DCI message, where the downlink DCI message indicates the timing advance command instead of scheduling a downlink shared channel message, or activating or releasing an SPS configuration.

Aspect 79: The apparatus of any of aspects 76 through 78, where to obtain the uplink message, the one or more interfaces are further configured to: obtain the uplink message via one or more CCs that are associated with a TAG-ID that is included in the timing advance command.

Aspect 80: The apparatus of any of aspects 76 through 78, where to obtain the uplink message, the one or more interfaces are further configured to: obtain the uplink message via one of one or more CCs, the one of the one or more component carriers being selected based on whether a CIF is present in the DCI message.

Aspect 81: The apparatus of aspect 80, where the CIF is present in the DCI message, the one or more CCs being associated with a TAG-ID associated with a CC indicated by the CIF.

Aspect 82: The apparatus of aspect 80, where the CIF is absent from the DCI message, the one or more CCs being associated with a TAG-ID associated with a default CC.

Aspect 83: The apparatus of aspect 82, where the default CC is an uplink CC that is associated with a downlink CC in which the DCI message is output.

Aspect 84: The apparatus of aspect 80, where uplink message in the one or more CCs is associated with a CORESET pool index of a CORESET in which the DCI message was output.

Aspect 85: The apparatus of any of aspects 76 through 84, where the timing advance command is a timing advance adjustment index value associated with a CORESET pool index.

Aspect 86: The apparatus of any of aspects 76 through 85, where a CORESET pool index associated with the timing advance command is a same as that in which the DCI message was output.

Aspect 87: The apparatus of any of aspects 76 through 85, where a CORESET pool index associated with the timing advance command is a same as that which is associated with a TAG-ID included in the DCI message.

Aspect 88: The apparatus of any of aspects 76 through 85, where the timing advance command is a timing advance adjustment offset value associated with a first CORESET pool index and represents a timing advance offset with respect to a timing advance adjustment value associated with a reference CORESET pool index.

Aspect 89: The apparatus of aspect 88, where the one or more interfaces are further configured to: output an indication of the reference CORESET pool index.

Aspect 90: The apparatus of any of aspects 76 through 85, where the timing advance command is a timing advance offset value associated with a first CORESET pool index and represents a timing advance offset with respect to a timing advance value associated with a reference CORESET pool index.

Aspect 91: The apparatus of aspect 90, the one or more interfaces are further configured to: output an indication of the reference CORESET pool index.

Aspect 92: The apparatus of any of aspects 76 through 91, where the one or more fields that are populated with the values that indicate that the DCI message includes the timing advance command include at least one of an RV field, an MCS field, an NDI field, an FDRA field, or an HPN field.

Aspect 93: The apparatus of any of aspects 76 through 92, where the timing advance command is indicated within the DCI message in at least one of a TDRA field, an HPN field, a frequency hopping flag field, a TPC field, a PUCCH resource indicator field, or an PDSCH-to-HARQ feedback timing indicator field.

Aspect 94: The apparatus of any of aspects 76 through 93, where the timing advance command indicates a timing adjustment with respect to a previous timing advance.

Aspect 95: The apparatus of any of aspects 76 through 93, where the timing advance command indicates an absolute timing advance.

Aspect 96: The apparatus of any of aspects 76 through 95, where the one or more fields of the DCI message populated with values that indicate that the DCI message includes the timing advance command are not populated with values that indicate the scheduling information for the communication between the UE and the network entity.

Aspect 97: An apparatus for wireless communications at a UE, including: means for receiving a DCI message including one or more fields associated with scheduling information for a communication between the UE and a network entity, where the DCI message is received in a DCI format that includes an CRC scrambled by a CS-RNTI, the one or more fields being populated with values that indicate that the DCI message includes a timing advance command; and means for transmitting, to the network entity, an uplink message associated with the timing advance command indicated in the DCI message.

Aspect 98: The apparatus of aspect 97, where the means for receiving the DCI message include: means for receiving an uplink DCI message, where the uplink DCI message indicates the timing advance command instead of scheduling an uplink shared channel message, or activating or releasing a CG configuration.

Aspect 99: The apparatus of aspect 97, where the means for receiving the DCI message include: means for receiving a downlink DCI message, where the downlink DCI message indicates the timing advance command instead of scheduling a downlink shared channel message, or activating or releasing a SPS configuration.

Aspect 100: The apparatus of any of aspects 97 through 99, where the means for transmitting the uplink message associated with the timing advance command further include: means for applying the timing advance command to the uplink message which is scheduled on one of one or more CCs that are associated with a TAG-ID that is included in the timing advance command.

Aspect 101: The apparatus of aspect 100, where each of the one or more CCs is associated with a single timing advance command, the apparatus further including: means for applying the timing advance command to the uplink message in one of the one or more CCs, the one of the one or more CCs being associated with the TAG-ID that is included in the timing advance command.

Aspect 102: The apparatus of aspect 100, where each of the one or more CCs is associated with multiple different timing advance commands with corresponding different TAG-IDs, the apparatus further including: means for applying the timing advance command to the uplink message in one of the one or more CCs, the uplink message in one of the one or more CCs being associated with a CORESET pool index that is also associated with the TAG-ID that is included in the timing advance command.

Aspect 103: The apparatus of aspect 100, where each of the one or more CCs is associated with multiple different timing advance commands all associated with the TAG-ID, the apparatus further including: means for applying the timing advance command to the uplink message in the one or more CCs, the uplink message in the one or more CCs being associated with a CORESET pool index in which the DCI message was received.

Aspect 104: The apparatus of any of aspects 97 through 99, where the means for transmitting the uplink message associated with the timing advance command further include: means for applying the timing advance command to the uplink message which is scheduled in one of one or more CCs, the one of the one or more component carriers being selected based on whether a CIF is present in the DCI message.

Aspect 105: The apparatus of aspect 104, where the CIF is present in the DCI message, the one of the one or more CCs being associated with a TAG-ID associated with a CC indicated by the CIF.

Aspect 106: The apparatus of aspect 104, where the CIF is absent from the DCI message, the one of the one or more CCs being associated with a TAG-ID associated with a default CC.

Aspect 107: The apparatus of aspect 106, where the default CC is an uplink CC that is associated with a downlink CC in which the DCI message is received.

Aspect 108: The apparatus of aspect 104, where the uplink message in one of the one or more CCs is associated with a CORESET pool index of a CORESET in which the DCI message was received.

Aspect 109: The apparatus of any of aspects 97 through 108, where the means for receiving the DCI message include: means for receiving the DCI message in one or more symbols of a DCI reception slot, where the timing advance command is applicable a determined number of slots after a designated slot associated with the DCI reception slot, the determined number of slots being based on a SPS PDSCH release processing capability of the UE.

Aspect 110: The apparatus of aspect 109, where the designated slot is a last slot of a set of multiple uplink slots that overlap with the DCI reception slot.

Aspect 111: The apparatus of aspect 109, where the designated slot is a last slot of a set of multiple uplink slots that overlap with the one or more symbols of the DCI reception slot.

Aspect 112: The apparatus of any of aspects 97 through 111, where the means for transmitting the uplink message associated with the timing advance command indicated in the DCI message further include: means for transmitting the uplink message using a timing advance that is based on a previous timing advance value associated with the CORESET pool index and the timing advance adjustment index value.

Aspect 113: The apparatus of aspect 112, where the CORESET pool index is a same as that in which the DCI message was received.

Aspect 114: The apparatus of aspect 112, where the CORESET pool index is a same as that which is associated with TAG-ID included in the DCI message.

Aspect 115: The apparatus of any of aspects 97 through 111, where the timing advance command is a timing advance adjustment offset value associated with a first CORESET pool index and the means for represents a timing advance offset with respect to a timing advance adjustment value associated with a reference CORESET pool index, where transmitting the uplink message associated with the timing advance command indicated in the DCI message further include: means for transmitting the uplink message using a timing advance that is based on a previous timing advance value associated with the first CORESET pool index, the timing advance adjustment value associated with the reference CORESET pool index, and the timing advance adjustment offset value associated with the first CORESET pool index.

Aspect 116: The apparatus of aspect 115, further including: means for receiving an indication of the reference CORESET pool index.

Aspect 117: The apparatus of any of aspects 97 through 111, where the timing advance command is a timing advance offset value associated with a first CORESET pool index and the means for represents a timing advance offset with respect to a timing advance value associated with a reference CORESET pool index, where transmitting the uplink message associated with the timing advance command indicated in the DCI message further include: means for transmitting the uplink message using a timing advance that is based on a current timing advance value associated with the reference CORESET pool index and the timing advance offset value associated with the first CORESET pool index.

Aspect 118: The apparatus of aspect 117, further including: means for receiving an indication of the reference CORESET pool index.

Aspect 119: The apparatus of any of aspects 97 through 118, where the one or more fields that are populated with the values that indicate that the DCI message includes the timing advance command include at least one of an RV field, an MCS field, an NDI field, an FDRA field, or an HPN field.

Aspect 120: The apparatus of any of aspects 97 through 119, where the timing advance command is indicated within the DCI message in at least one of a TDRA field, an HPN field, a frequency hopping flag field, a TPC field, a PUCCH resource indicator field, or an PDSCH-to-HARQ feedback timing indicator field.

Aspect 121: The apparatus of any of aspects 97 through 120, where the timing advance command indicates a timing adjustment with respect to a previous timing advance.

Aspect 122: The apparatus of any of aspects 97 through 120, where the timing advance command indicates an absolute timing advance.

Aspect 123: The apparatus of any of aspects 97 through 122, where the one or more fields of the DCI message populated with values that indicate that the DCI message includes the timing advance command are not populated with values that indicate the scheduling information for the communication between the UE and the network entity.

Aspect 124: An apparatus for wireless communications at a network entity, including: means for transmitting, to a UE, a DCI message including one or more fields associated with scheduling information for a communication between the network entity and the UE, where the DCI message is transmitted in a DCI format that includes an CRC scrambled by a CS-RNTI, the one or more fields being populated with values that indicate that the DCI message includes a timing advance command; and means for receiving, from the UE, an uplink message associated with the timing advance command indicated in the DCI message.

Aspect 125: The apparatus of aspect 124, where the means for transmitting the DCI message include: means for transmitting an uplink DCI message, where the uplink DCI message indicates the timing advance command instead of scheduling an uplink shared channel message, or activating or releasing a CG configuration.

Aspect 126: The apparatus of aspect 124, where the means for transmitting the DCI message include: means for transmitting a downlink DCI message, where the downlink DCI message indicates the timing advance command instead of scheduling a downlink shared channel message, or activating or releasing a SPS configuration.

Aspect 127: The apparatus of any of aspects 124 through 126, where the means for receiving the uplink message further include: means for receiving the uplink message via one or more CCs that are associated with a TAG-ID that is included in the timing advance command.

Aspect 128: The apparatus of any of aspects 124 through 126, where the means for receiving the uplink message further include: means for receiving the uplink message via one of one or more CCs, the one of the one or more component carriers being selected based on whether a CIF is present in the DCI message.

Aspect 129: The apparatus of aspect 128, where the CIF is present in the DCI message, the one or more CCs being associated with a TAG-ID associated with a CC indicated by the CIF.

Aspect 130: The apparatus of aspect 128, where the CIF is absent from the DCI message, the one or more CCs being associated with a TAG-ID associated with a default CC.

Aspect 131: The apparatus of aspect 130, where the default CC is an uplink CC that is associated with a downlink CC in which the DCI message is transmitted.

Aspect 132: The apparatus of aspect 128, where uplink message in the one or more CCs is associated with a CORESET pool index of a CORESET in which the DCI message was transmitted.

Aspect 133: The apparatus of any of aspects 124 through 132, where the timing advance command is a timing advance adjustment index value associated with a CORESET pool index.

Aspect 134: The apparatus of any of aspects 124 through 133, where a CORESET pool index associated with the timing advance command is a same as that in which the DCI message was transmitted.

Aspect 135: The apparatus of any of aspects 124 through 133, where a CORESET pool index associated with the timing advance command is a same as that which is associated with a TAG-ID included in the DCI message.

Aspect 136: The apparatus of any of aspects 124 through 133, where the timing advance command is a timing advance adjustment offset value associated with a first CORESET pool index and represents a timing advance offset with respect to a timing advance adjustment value associated with a reference CORESET pool index.

Aspect 137: The apparatus of aspect 136, further including: means for transmitting an indication of the reference CORESET pool index.

Aspect 138: The apparatus of any of aspects 124 through 133, where the timing advance command is a timing advance offset value associated with a first CORESET pool index and represents a timing advance offset with respect to a timing advance value associated with a reference CORESET pool index.

Aspect 139: The apparatus of aspect 138, further including: means for transmitting an indication of the reference CORESET pool index.

Aspect 140: The apparatus of any of aspects 124 through 139, where: the one or more fields that are populated with the values that indicate that the DCI message includes the timing advance command include at least one of an RV field, an MCS field, an NDI field, an FDRA field, or an HPN field.

Aspect 141: The apparatus of any of aspects 124 through 140, where the timing advance command is indicated within the DCI message in at least one of a TDRA field, an HPN field, a frequency hopping flag field, a TPC field, a PUCCH resource indicator field, or an PDSCH-to-HARQ feedback timing indicator field.

Aspect 142: The apparatus of any of aspects 124 through 141, where the timing advance command indicates a timing adjustment with respect to a previous timing advance.

Aspect 143: The apparatus of any of aspects 124 through 141, where the timing advance command indicates an absolute timing advance.

Aspect 144: The apparatus of any of aspects 124 through 143, where the one or more fields of the DCI message populated with values that indicate that the DCI message includes the timing advance command are not populated with values that indicate the scheduling information for the communication between the UE and the network entity.

Aspect 145: A non-transitory computer-readable medium storing code for wireless communications at a UE, the code including instructions executable by a processor to: receive a DCI message including one or more fields associated with scheduling information for a communication between the UE and a network entity, where the DCI message is received in a DCI format that includes an CRC scrambled by a CS-RNTI, the one or more fields being populated with values that indicate that the DCI message includes a timing advance command; and transmit, to the network entity, an uplink message associated with the timing advance command indicated in the DCI message.

Aspect 146: The non-transitory computer-readable medium of aspect 145, where the instructions to receive the DCI message are executable by the processor to: receive an uplink DCI message, where the uplink DCI message indicates the timing advance command instead of scheduling an uplink shared channel message, or activating or releasing a CG configuration.

Aspect 147: The non-transitory computer-readable medium of aspect 145, where the instructions to receive the DCI message are executable by the processor to: receive a downlink DCI message, where the downlink DCI message indicates the timing advance command instead of scheduling a downlink shared channel message, or activating or releasing a SPS configuration.

Aspect 148: The non-transitory computer-readable medium of aspects 145 through 147, where the instructions to transmit the uplink message associated with the timing advance command are further executable by the processor to: apply the timing advance command to the uplink message which is scheduled on one of one or more CCs that are associated with a TAG-ID that is included in the timing advance command.

Aspect 149: The non-transitory computer-readable medium of aspect 148, where each of the one or more CCs is associated with a single timing advance command, and the instructions are further executable by the processor to: apply the timing advance command to the uplink message in one of the one or more CCs, the one of the one or more CCs being associated with the TAG-ID that is included in the timing advance command.

Aspect 150: The non-transitory computer-readable medium of aspect 148, where each of the one or more CCs is associated with multiple different timing advance commands with corresponding different TAG-IDs, and the instructions are further executable by the processor to: apply the timing advance command to the uplink message in one of the one or more CCs, the uplink message in one of the one or more CCs being associated with a CORESET pool index that is also associated with the TAG-ID that is included in the timing advance command.

Aspect 151: The non-transitory computer-readable medium of aspect 148, where each of the one or more CCs is associated with multiple different timing advance commands all associated with the TAG-ID, and the instructions are further executable by the processor to: apply the timing advance command to the uplink message in the one or more CCs, the uplink message in the one or more CCs being associated with a CORESET pool index in which the DCI message was received.

Aspect 152: The non-transitory computer-readable medium of 145 through 147, where the instructions to transmit the uplink message associated with the timing advance command are further executable by the processor to: apply the timing advance command to the uplink message which is scheduled in one of one or more CCs, the one of the one or more component carriers being selected based on whether a CIF is present in the DCI message.

Aspect 153: The non-transitory computer-readable medium of aspect 152, where the CIF is present in the DCI message, the one of the one or more CCs being associated with a TAG-ID associated with a CC indicated by the CIF.

Aspect 154: The non-transitory computer-readable medium of aspect 152, where the CIF is absent from the DCI message, the one of the one or more CCs being associated with a TAG-ID associated with a default CC.

Aspect 155: The non-transitory computer-readable medium of aspect 154, where the default CC is an uplink CC that is associated with a downlink CC in which the DCI message is received.

Aspect 156: The non-transitory computer-readable medium of aspect 152, where the uplink message in one of the one or more CCs is associated with a CORESET pool index of a CORESET in which the DCI message was received.

Aspect 157: The non-transitory computer-readable medium of any of aspects 145 through 156, where the instructions to receive the DCI message are executable by the processor to: receive the DCI message in one or more symbols of a DCI reception slot, where the timing advance command is applicable a determined number of slots after a designated slot associated with the DCI reception slot, the determined number of slots being based on a SPS PDSCH release processing capability of the UE.

Aspect 158: The non-transitory computer-readable medium of aspect 157, where the designated slot is a last slot of a set of multiple uplink slots that overlap with the DCI reception slot.

Aspect 159: The non-transitory computer-readable medium of aspect 157, where the designated slot is a last slot of a set of multiple uplink slots that overlap with the one or more symbols of the DCI reception slot.

Aspect 160: The non-transitory computer-readable medium of any of aspects 145 through 159, where the instructions to transmit the uplink message associated with the timing advance command indicated in the DCI message are further executable by the processor to: transmit the uplink message using a timing advance that is based on a previous timing advance value associated with the CORESET pool index and the timing advance adjustment index value.

Aspect 161: The non-transitory computer-readable medium of aspect 160, where the CORESET pool index is a same as that in which the DCI message was received.

Aspect 162: The non-transitory computer-readable medium of aspect 160, where the CORESET pool index is a same as that which is associated with a TAG-ID included in the DCI message.

Aspect 163: The non-transitory computer-readable medium of any of aspects 145 through 159, where the timing advance command is a timing advance adjustment offset value associated with a first CORESET pool index and the instructions to represent a timing advance offset with respect to a timing advance adjustment value associated with a reference CORESET pool index, where transmitting the uplink message associated with the timing advance command indicated in the DCI message are further executable by the processor to: transmit the uplink message using a timing advance that is based on a previous timing advance value associated with the first CORESET pool index, the timing advance adjustment value associated with the reference CORESET pool index, and the timing advance adjustment offset value associated with the first CORESET pool index.

Aspect 164: The non-transitory computer-readable medium of aspect 163, where the instructions are further executable by the processor to: receive an indication of the reference CORESET pool index.

Aspect 165: The non-transitory computer-readable medium of any of aspects 145 through 159, where the timing advance command is a timing advance offset value associated with a first CORESET pool index and the instructions to represent a timing advance offset with respect to a timing advance value associated with a reference CORESET pool index, where transmitting the uplink message associated with the timing advance command indicated in the DCI message are further executable by the processor to: transmit the uplink message using a timing advance that is based on a current timing advance value associated with the reference CORESET pool index and the timing advance offset value associated with the first CORESET pool index.

Aspect 166: The non-transitory computer-readable medium of aspect 165, where the instructions are further executable by the processor to: receive an indication of the reference CORESET pool index.

Aspect 167: The non-transitory computer-readable medium of any of aspects 145 through 166, where the one or more fields that are populated with the values that indicate that the DCI message includes the timing advance command include at least one of an RV field, an MCS field, an NDI field, an FDRA field, or an HPN field.

Aspect 168: The non-transitory computer-readable medium of any of aspects 145 through 167, where the timing advance command is indicated within the DCI message in at least one of a TDRA field, an HPN field, a frequency hopping flag field, a TPC field, a PUCCH resource indicator field, or an PDSCH-to-HARQ feedback timing indicator field.

Aspect 169: The non-transitory computer-readable medium of any of aspects 145 through 168, where the timing advance command indicates a timing adjustment with respect to a previous timing advance.

Aspect 170: The non-transitory computer-readable medium of any of aspects 145 through 168, where the timing advance command indicates an absolute timing advance.

Aspect 171: The non-transitory computer-readable medium of any of aspects 145 through 170, where the one or more fields of the DCI message populated with values that indicate that the DCI message includes the timing advance command are not populated with values that indicate the scheduling information for the communication between the UE and the network entity.

Aspect 172: A non-transitory computer-readable medium storing code for wireless communications at a network entity, the code including instructions executable by a processor to: transmit, to a UE, a DCI message including one or more fields associated with scheduling information for a communication between the network entity and the UE, where the DCI message is transmitted in a DCI format that includes an CRC scrambled by a CS-RNTI, the one or more fields being populated with values that indicate that the DCI message includes a timing advance command; and receive, from the UE, an uplink message associated with the timing advance command indicated in the DCI message.

Aspect 173: The non-transitory computer-readable medium of aspect 172, where the instructions to transmit the DCI message are executable by the processor to: transmit an uplink DCI message, where the uplink DCI message indicates the timing advance command instead of scheduling an uplink shared channel message, or activating or releasing a CG configuration.

Aspect 174: The non-transitory computer-readable medium of aspect 172, where the instructions to transmit the DCI message are executable by the processor to: transmit a downlink DCI message, where the downlink DCI message indicates the timing advance command instead of scheduling a downlink shared channel message, or activating or releasing a SPS configuration.

Aspect 175: The non-transitory computer-readable medium of any of aspects 172 through 174, where the instructions to receive the uplink message are further executable by the processor to: receive the uplink message via one or more CCs that are associated with a TAG-ID that is included in the timing advance command.

Aspect 176: The non-transitory computer-readable medium of any of aspects 172 through 174, where the instructions to receive the uplink message are further executable by the processor to: receive the uplink message via one of one or more CCs, the one of the one or more component carriers being selected based on whether a CIF is present in the DCI message.

Aspect 177: The non-transitory computer-readable medium of aspect 176, where the CIF is present in the DCI message, the one or more CCs being associated with a TAG-ID associated with a CC indicated by the CIF.

Aspect 178: The non-transitory computer-readable medium of aspect 176, where the CIF is absent from the DCI message, the one or more CCs being associated with a TAG-ID associated with a default CC.

Aspect 179: The non-transitory computer-readable medium of aspect 178, where the default CC is an uplink CC that is associated with a downlink CC in which the DCI message is transmitted.

Aspect 180: The non-transitory computer-readable medium of aspect 176, where uplink message in the one or more CCs is associated with a CORESET pool index of a CORESET in which the DCI message was transmitted.

Aspect 181: The non-transitory computer-readable medium of any of aspects 172 through 180, where the timing advance command is a timing advance adjustment index value associated with a CORESET pool index.

Aspect 182: The non-transitory computer-readable medium of any of aspects 172 through 181, where a CORESET pool index associated with the timing advance command is a same as that in which the DCI message was transmitted.

Aspect 183: The non-transitory computer-readable medium of any of aspects 172 through 181, where a CORESET pool index associated with the timing advance command is a same as that which is associated with a TAG-ID included in the DCI message.

Aspect 184: The non-transitory computer-readable medium of any of aspects 172 through 181, where the timing advance command is a timing advance adjustment offset value associated with a first CORESET pool index and represents a timing advance offset with respect to a timing advance adjustment value associated with a reference CORESET pool index.

Aspect 185: The non-transitory computer-readable medium of aspect 184, where the instructions are further executable by the processor to: transmit an indication of the reference CORESET pool index.

Aspect 186: The non-transitory computer-readable medium of any of aspects 172 through 181, where the timing advance command is a timing advance offset value associated with a first CORESET pool index and represents a timing advance offset with respect to a timing advance value associated with a reference CORESET pool index.

Aspect 187: The non-transitory computer-readable medium of aspect 186, where the instructions are further executable by the processor to: transmit an indication of the reference CORESET pool index.

Aspect 188: The non-transitory computer-readable medium of any of aspects 172 through 187, where the one or more fields that are populated with the values that indicate that the DCI message includes the timing advance command include at least one of an RV field, an MCS field, an NDI field, an FDRA field, or an HPN field.

Aspect 189: The non-transitory computer-readable medium of any of aspects 172 through 188, where the timing advance command is indicated within the DCI message in at least one of a TDRA field, an HPN field, a frequency hopping flag field, a TPC field, a PUCCH resource indicator field, or an PDSCH-to-HARQ feedback timing indicator field.

Aspect 190: The non-transitory computer-readable medium of any of aspects 172 through 189, where the timing advance command indicates a timing adjustment with respect to a previous timing advance.

Aspect 191: The non-transitory computer-readable medium of any of aspects 172 through 189, where the timing advance command indicates an absolute timing advance.

Aspect 192: The non-transitory computer-readable medium of any of aspects 172 through 191, where the one or more fields of the DCI message populated with values that indicate that the DCI message includes the timing advance command are not populated with values that indicate the scheduling information for the communication between the UE and the network entity

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and the like. Also, “determining” can include receiving (such as receiving information), accessing (such as accessing data stored in memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented using hardware or software depends upon the particular application and design constraints imposed on the overall system.

The hardware and data processing apparatus used to implement the various illustrative logics, logical blocks, modules and circuits described in connection with the aspects disclosed herein may be implemented or performed using a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented using hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted using one or more instructions or code of a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one location to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc. Disks may reproduce data magnetically and discs may reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

What is claimed is:

1. An apparatus for wireless communications at a user equipment (UE), comprising:
one or more interfaces configured to:
obtain a downlink control information (DCI) message comprising one or more fields associated with scheduling information for a communication between the UE and a network entity, wherein the DCI message is obtained in a DCI format that includes a cyclic redundancy check (CRC) scrambled by a configured scheduling radio network temporary identifier (CS-RNTI), the one or more fields being populated with values that indicate that the DCI message includes a timing advance command; and
output an uplink message associated with the timing advance command indicated in the DCI message.

2. The apparatus of claim 1, wherein to obtain the DCI message, the one or more interfaces are further configured to:
obtain an uplink DCI message, wherein the uplink DCI message indicates the timing advance command instead of scheduling an uplink shared channel message, or activating or releasing a configured grant (CG) configuration.

3. The apparatus of claim 1, wherein to obtain the DCI message, the one or more interfaces are further configured to:
obtain a downlink DCI message, wherein the downlink DCI message indicates the timing advance command instead of scheduling a downlink shared channel message, or activating or releasing a semi-persistent scheduling (SPS) configuration.

4. The apparatus of claim 1, wherein to output the uplink message associated with the timing advance command, the one or more interfaces are further configured to:
apply the timing advance command to the uplink message which is scheduled on one of one or more component carriers (CCs) that are associated with a timing advance group identifier (TAG-ID) that is included in the timing advance command.

5. The apparatus of claim 4, wherein each of the one or more CCs is associated with a single timing advance command, and wherein the one or more interfaces are further configured to:
apply the timing advance command to the uplink message in one of the one or more CCs, the one of the one or more CCs being associated with the TAG-ID that is included in the timing advance command.

6. The apparatus of claim 4, wherein each of the one or more CCs is associated with multiple different timing advance commands with corresponding different TAG-IDs, and the one or more interfaces are further configured to:
apply the timing advance command to the uplink message in one of the one or more CCs, the uplink message in one of the one or more CCs being associated with a control resource set (CORESET) pool index that is also associated with the TAG-ID that is included in the timing advance command.

7. The apparatus of claim 4, wherein each of the one or more CCs is associated with multiple different timing advance commands all associated with the TAG-ID, and the one or more interfaces are further configured to:
apply the timing advance command to the uplink message in the one or more CCs, the uplink message in the one or more CCs being associated with a control resource set (CORESET) pool index in which the DCI message was obtained.

8. The apparatus of claim 1, wherein to output the uplink message associated with the timing advance command, the one or more interfaces are further configured to:
apply the timing advance command to the uplink message which is scheduled in one of one or more component carriers (CCs), the one of the one or more component carriers being selected based at least in part on whether a carrier indicator field (CIF) is present in the DCI message.

9. The apparatus of claim 1, wherein to obtain the DCI message, the one or more interfaces are further configured to:
obtain the DCI message in one or more symbols of a DCI reception slot, wherein the timing advance command is applicable a determined number of slots after a designated slot associated with the DCI reception slot, the determined number of slots being based at least in part on a semi-persistent scheduling (SPS) physical downlink shared channel (PDSCH) release processing capability of the UE.

10. The apparatus of claim 1, wherein the timing advance command is a timing advance adjustment index value associated with a control resource set (CORESET) pool index, wherein to output the uplink message associated with the timing advance command indicated in the DCI message the one or more interfaces are further configured to:
output the uplink message using a timing advance that is based on a previous timing advance value associated with the CORESET pool index and the timing advance adjustment index value.

11. The apparatus of claim 10, wherein the CORESET pool index is a same as that in which the DCI message was obtained.

12. The apparatus of claim 10, wherein the CORESET pool index is a same as that which is associated with a timing group advance identifier (TAG-ID) included in the DCI message.

13. The apparatus of claim 1, wherein the timing advance command is a timing advance adjustment offset value associated with a first control resource set (CORESET) pool index and represents a timing advance offset with respect to a timing advance adjustment value associated with a reference CORESET pool index, wherein to output the uplink message associated with the timing advance command indicated in the DCI message, the one or more interfaces are further configured to:
output the uplink message using a timing advance that is based on a previous timing advance value associated with the first CORESET pool index, the timing advance adjustment value associated with the reference CORESET pool index, and the timing advance adjustment offset value associated with the first CORESET pool index.

14. The apparatus of claim 1, wherein the timing advance command is a timing advance offset value associated with a first control resource set (CORESET) pool index and represents a timing advance offset with respect to a timing advance value associated with a reference CORESET pool index, wherein to output the uplink message associated with the timing advance command indicated in the DCI message, the one or more interfaces are further configured to:
output the uplink message using a timing advance that is based on a current timing advance value associated with the reference CORESET pool index and the timing advance offset value associated with the first CORESET pool index.

15. The apparatus of claim 1, wherein the one or more fields of the DCI message populated with values that indicate that the DCI message includes the timing advance command are not populated with values that indicate the scheduling information for the communication between the UE and the network entity.

16. An apparatus for wireless communications at a network entity, comprising:
one or more interfaces configured to:
output, to a user equipment (UE), a downlink control information (DCI) message comprising one or more fields associated with scheduling information for a communication between the network entity and the UE, wherein the DCI message is output in a DCI format that includes a cyclic redundancy check (CRC) scrambled by a configured scheduling radio network temporary identifier (CS-RNTI), the one or more fields being populated with values that indicate that the DCI message includes a timing advance command: and
obtain, from the UE, an uplink message associated with the timing advance command indicated in the DCI message.

17. The apparatus of claim 16, wherein to output the DCI message, the one or more interfaces are further configured to:
output an uplink DCI message, wherein the uplink DCI message indicates the timing advance command instead of scheduling an uplink shared channel message, or activating or releasing a configured grant (CG) configuration.

18. The apparatus of claim 16, wherein to output the DCI message, the one or more interfaces are further configured to:
output a downlink DCI message, wherein the downlink DCI message indicates the timing advance command instead of scheduling a downlink shared channel message, or activating or releasing a semi-persistent scheduling (SPS) configuration.

19. The apparatus of claim 16, wherein to obtain the uplink message, the one or more interfaces are further configured to:
obtain the uplink message via one or more component carriers (CCs) that are associated with a timing advance group identifier (TAG-ID) that is included in the timing advance command.

20. The apparatus of claim 16, wherein to obtain the uplink message, the one or more interfaces are further configured to:
obtain the uplink message via one of one or more component carriers (CCs), the one of the one or more component carriers being selected based at least in part on whether a carrier indicator field (CIF) is present in the DCI message.

21. The apparatus of claim 16, wherein a control resource set (CORESET) pool index associated with the timing advance command is a same as that which is associated with a timing group advance identifier (TAG-ID) included in the DCI message.

22. The apparatus of claim 16, wherein the timing advance command is a timing advance adjustment offset value associated with a first control resource set (CORESET) pool index and represents a timing advance offset with respect to a timing advance adjustment value associated with a reference CORESET pool index.

23. The apparatus of claim 16, wherein the timing advance command is a timing advance offset value associated with a first control resource set (CORESET) pool index and represents a timing advance offset with respect to a timing advance value associated with a reference CORESET pool index.

24. The apparatus of claim 16, wherein the one or more fields of the DCI message populated with values that indicate that the DCI message includes the timing advance command are not populated with values that indicate the scheduling information for the communication between the UE and the network entity.

25. A method for wireless communications at a user equipment (UE), comprising:
receiving a downlink control information (DCI) message comprising one or more fields associated with scheduling information for a communication between the UE and a network entity, wherein the DCI message is received in a DCI format that includes a cyclic redundancy check (CRC) scrambled by a configured scheduling radio network temporary identifier (CS-RNTI), the one or more fields being populated with values that indicate that the DCI message includes a timing advance command; and
transmitting, to the network entity, an uplink message associated with the timing advance command indicated in the DCI message.

26. The method of claim 25, wherein receiving the DCI message comprises:
receiving an uplink DCI message, wherein the uplink DCI message indicates the timing advance command instead of scheduling an uplink shared channel message, or activating or releasing a configured grant (CG) configuration.

27. The method of claim 25, wherein receiving the DCI message comprises:
receiving a downlink DCI message, wherein the downlink DCI message indicates the timing advance command instead of scheduling a downlink shared channel message, or activating or releasing a semi-persistent scheduling (SPS) configuration.

28. A method for wireless communications at a network entity, comprising:
transmitting, to a user equipment (UE), a downlink control information (DCI) message comprising one or more fields associated with scheduling information for a communication between the network entity and the UE, wherein the DCI message is transmitted in a DCI format that includes a cyclic redundancy check (CRC) scrambled by a configured scheduling radio network temporary identifier (CS-RNTI), the one or more fields being populated with values that indicate that the DCI message includes a timing advance command; and
receiving, from the UE, an uplink message associated with the timing advance command indicated in the DCI message.

29. The method of claim 28, wherein transmitting the DCI message comprises:
transmitting an uplink DCI message, wherein the uplink DCI message indicates the timing advance command instead of scheduling an uplink shared channel message, or activating or releasing a configured grant (CG) configuration.

30. The method of claim 28, wherein transmitting the DCI message comprises:
transmitting a downlink DCI message, wherein the downlink DCI message indicates the timing advance command instead of scheduling a downlink shared channel message, or activating or releasing a semi-persistent scheduling (SPS) configuration.
